(19) United States
(12) Patent Application Publication
(10) Pub. No.: US 2002/0045696 A1
(43) Pub. Date: Apr. 18, 2002

(54) Golf ball with dual core and polyurethane cover

(75) Inventors: Michael J. Sullivan, Barrington, RI (US); R. Dennis Nesbitt, Westfield, MA (US); Thomas J. Kennedy III, Wilbraham, MA (US); Michael John Tzivanis, Chicopee, MA (US); Mark L. Binette, Ludlow, MA (US); Viktor Keller, Enfield, CT (US); William M. Risen JR., Rumford, RI (US)

Correspondence Address: MICHELLE BUGBEE, ASSOCIATE PATENT COUNSEL, SPALDING SPORTS WORLDWIDE INC, 425 MEADOW STREET, PO BOX 901, CHICOPEE, MA, 01021-0901, US

(73) Assignee: SPALDING SPORTS WORLDWIDE, INC.

(21) Appl. No.: 09/840,475

(22) Filed: Apr. 23, 2001

Related U.S. Application Data
(63) Continuation-in-part of application No. 09/562,773, filed on May 2, 2000.
Application No. 09/562,773 is a continuation of application No. 09/049,410, filed on Mar. 27, 1998, now Pat. No. 6,057,403.
Application No. 09/049,410 is a continuation-in-part of application No. 08/926,872, filed on Sep. 10, 1997.
Application No. 08/926,872 is a division of application No. 08/631,613, filed on Apr. 10, 1996, now Pat. No. 5,803,831.
Application No. 08/631,613 is a continuation-in-part of application No. 08/591,046, filed on Jan. 25, 1996, now abandoned.
Application No. 08/631,613 is a continuation-in-part of application No. 08/870,585, filed on Jun. 6, 1997, now abandoned.
Application No. 08/870,585 is a continuation of application No. 08/556,237, filed on Nov. 9, 1995, now abandoned.
Application No. 08/556,237 is a continuation of application No. 08/542,793, filed on Oct. 13, 1995, now abandoned.
Application No. 08/542,793 is a continuation-in-part of application No. 08/070,510, filed on Jun. 1, 1993, now abandoned.
(60) Provisional application No. 60/042,439, filed on Mar. 28, 1997.

(51) Int. Cl. C08K 3/08; A63B 37/00

(52) U.S. Cl. 524/439; 524/440; 473/351

(57) ABSTRACT

The present invention is directed to a golf ball comprising a dual core assembly and a cover layer. The dual core comprises an interior spherical center component formed from a thermoset polymeric material, a thermoplastic polymeric material, or combinations thereof. The center component comprises one or more density adjusting filler materials dispersed throughout the polymeric material. The dual core also comprises a core layer disposed about the center component, formed from a thermoset material, a thermoplastic material, or combinations thereof. The present invention golf ball may further comprise an outer core layer that surrounds the dual core. The cover layer is either a single cover layer or a multi-layer cover assembly and preferably includes a polyurethane material. It is preferred that the inner and outer cover layers differ in hardness by at least 5 on the Shore D scale. The resulting multi-layered golf ball of the present invention provides for enhanced distance without sacrificing playability or durability when compared to known multi-layer golf balls.

### CROSS REFERENCES TO RELATED APPLICATIONS

This application is a continuation-in-part of U.S. application Ser. No. 09/562,773 filed on May 2, 2000 which is a continuation of U.S. application Ser. No. 09/049,410 filed on Mar. 27,1998, now U.S. Pat. No. 6,057,403, which is a continuation-in-part of U.S. application Ser. No. 08/926,872 filed on Sep. 10, 1997, which is a divisional of U.S. application Ser. No. 08/631,613 filed on Apr. 10, 1996, which in turn is a continuation-in-part of U.S. application Ser. No. 08/591,046 filed on Jan. 25, 1996, and U.S. application Ser. No. 08/542,793 filed on Oct. 13, 1995, which in turn is a continuation-in-part of U.S. application Ser. No. 08/070,510 filed Jun. 1, 1993. This application is also a continuation-in-part of U.S. application Ser. No. 08/870,585 filed on Jun. 6, 1997, which is a continuation of U.S. application Ser. No. 08/556,237 filed on Nov. 9, 1995, which is a continuation-in-part of U.S. application Ser. No. 08/542,793 filed Oct. 13, 1995, which is a continuation-in-part of U.S. application Ser. No. 08/070,510 filed on Jun. 1, 1993. This application also claims priority on U.S. provisional patent application Ser. No. 60/042,439 filed Mar. 28, 1997.

### FIELD OF THE INVENTION

The present invention relates to golf balls and, more particularly, to improved golf balls utilizing a dual core assembly having a core center with a particular combination of materials, each with certain densities. The present invention also relates to golf balls and, more particularly, to improved golf balls comprising single or multi-layer covers which utilize polyurethane materials. In several embodiments utilizing a multi-layer cover assembly, two of the individual cover layers are designed to provide certain hardness differentials between the respective cover layers. The improved multi-layer golf balls provide for enhanced distance and durability properties over comparable conventional golf balls while at the same time offering enhanced “feel” and spin characteristics generally associated with golf balls having soft balata and balata-like covers.

### BACKGROUND OF THE INVENTION

Traditional golf ball covers have been comprised of balata or blends of balata with elastomeric or plastic materials. The traditional balata covers are relatively soft and flexible. Upon impact, the soft balata covers compress against the surface of the club producing high spin. Consequently, the soft and flexible balata covers provide an experienced golfer with the ability to apply a spin to control the ball in flight in order to produce a draw or a fade, or a backspin which causes the ball to “bite” or stop abruptly on contact with the green. Moreover, the soft balata covers produce a soft “feel” to the low handicap player. Such playability properties (workability, feel, etc.) are particularly important in short iron play with low swing speeds and are exploited significantly by relatively skilled players.

Despite all the benefits of balata, balata covered golf balls are easily cut and/or damaged if mis-hit. Golf balls produced with balata or balata-containing cover compositions therefore have a relatively short lifespan.

As a result of this negative property, balata and its synthetic substitutes, transpolybutadiene and transpolyisoprene, have been essentially replaced as the cover materials of choice by new cover materials comprising ionomeric resins.

Ionomeric resins are polymers containing interchain ionic bonding. As a result of their toughness, durability and flight characteristics, various ionomeric resins sold by E. I. DuPont de Nemours & Company under the trademark Surlyn® and more recently, by the Exxon Corporation (see U.S. Pat. No. 4,911,451) under the trademarks Escor® and lotek®, have become the materials of choice for the construction of golf ball covers over the traditional “balata” (transpolyisoprene, natural or synthetic) rubbers. As stated, the softer balata covers, although exhibiting enhanced playability properties, lack the durability (cut and abrasion resistance, fatigue endurance, etc.) properties required for repetitive play.

Ionomeric resins are generally ionic copolymers of an olefin, such as ethylene, and a metal salt of an unsaturated carboxylic acid, such as acrylic acid, methacrylic acid, or maleic acid. Metal ions, such as sodium or zinc, are used to neutralize some portion of the acidic group in the copolymer resulting in a thermoplastic elastomer exhibiting enhanced properties, i.e. durability, etc., for golf ball cover construction over balata. However, some of the advantages gained in increased durability have been offset to some degree by the decreases produced in playability. This is because although the ionomeric resins are very durable, they tend to be very hard when utilized for golf ball cover construction, and thus lack the degree of softness required to impart the spin necessary to control the ball in flight. Since the ionomeric resins are harder than balata, the ionomeric resin covers do not compress as much against the face of the club upon impact, thereby producing less spin. In addition, the harder and more durable ionomeric resins lack the “feel” characteristic associated with the softer balata related covers.

As a result, while there are currently more than fifty (50) commercial grades of ionomers available both from DuPont and Exxon, with a wide range of properties which vary according to the type and amount of metal cations, molecular weight, composition of the base resin (i.e., relative content of ethylene and methacrylic and/or acrylic acid groups) and additive ingredients such as reinforcement agents, etc., a great deal of research continues in order to develop a golf ball cover composition exhibiting not only the improved impact resistance and carrying distance properties produced by the “hard” ionomeric resins, but also the playability (i.e., “spin,” “feel,” etc.) characteristics previously associated with the “soft” balata covers, properties which are still desired by the more skilled golfer.

Consequently, a number of two-piece (a solid resilient center or core with a molded cover) and three-piece (a liquid or solid center, elastomeric winding about the center, and a molded cover) golf balls have been produced to address these needs. The different types of materials utilized to formulate the cores, covers, etc. of these balls dramatically alter the balls' overall characteristics. In addition, multi-layered covers containing one or more ionomer resins have also been formulated in an attempt to produce a golf ball having the overall distance, playability and durability characteristics desired.

This was addressed by Spalding Sports Worldwide, Inc., the assignee of the present invention, in U.S. Pat. No. 4,431,193 where a multi-layered golf ball is produced by initially molding a first cover layer on a spherical core and then adding a second layer. The first layer is comprised of a hard, high flexural modulus resinous material such as type 1605 Surlyn® (now designated Surlyn® 8940). Type 1605 Surlyn® (Surlyn® 8940) is a sodium ion based low acid (less than or equal to 15 weight percent methacrylic acid) ionomer resin having a flexural modulus of about 51,000 psi. An outer layer of a comparatively soft, low flexural modulus resinous material such as type 1855 Surlyn® (now designated Surlyn® 9020) is molded over the inner cover layer. Type 1855 Surlyn® (Surlyn® 9020) is a zinc ion based low acid (10 weight percent methacrylic acid) ionomer resin having a flexural modulus of about 14,000 psi.

The '193 patent teaches that the hard, high flexural modulus resin which comprises the first layer provides for a gain in coefficient of restitution over the coefficient of restitution of the core. The increase in the coefficient of restitution provides a ball which serves to attain or approach the maximum initial velocity limit of 255 feet per second as provided by the United States Golf Association (U.S.G.A.) rules. The relatively soft, low flexural modulus outer layer provides for the advantageous “feel” and playing characteristics of a balata covered golf ball.

In various attempts to produce a durable, high spin ionomer golf ball, the golfing industry has blended the hard ionomer resins with a number of softer ionomeric resins. U.S. Pat. Nos. 4,884,814 and 5,120,791 are directed to cover compositions containing blends of hard and soft ionomeric resins. The hard copolymers typically are made from an olefin and an unsaturated carboxylic acid. The soft copolymers are generally made from an olefin, an unsaturated carboxylic acid, and an acrylate ester. It has been found that golf ball covers formed from hard-soft ionomer blends tend to become scuffed more readily than covers made of hard ionomer alone. It would be useful to develop a golf ball having a combination of softness and durability which is better than the softness-durability combination of a golf ball cover made from a hard-soft ionomer blend.

Most professional golfers and good amateur golfers desire a golf ball that provides distance when hit off a driver, control and stopping ability on full iron shots, and high spin on short “touch and feel” shots. Many conventional two-piece and thread wound performance golf balls have undesirable high spin rates on full shots. The excessive spin on full shots is a sacrifice made in order to achieve more spin which is desired on the shorter touch shots. It would be beneficial to provide a golf ball which has high spin for touch shots without generating excessive spin or full shots.

Concerning the configuration and construction of a golf ball core, it would also be desirable to utilize a core construction that enables the weight distribution and thus, moment of rotational inertia, to be readily adjusted while also addressing the previously noted concerns regarding golf ball covers.

These and other objects and features of the invention will be apparent from the following summary and description of the invention, the drawings and from the claims.

### SUMMARY OF THE INVENTION

The present invention provides all of the foregoing noted objectives and provides in the first aspect, a golf ball comprising a dual core assembly and a multi-layer cover assembly disposed about the dual core assembly. The dual core assembly includes a center core component and a core layer disposed about the center core component. The center core component has at least one density adjusting filler material dispersed throughout a polymeric material. The unique multi-layer cover assembly includes an inner cover layer disposed on the dual core assembly and an outer cover layer disposed on and generally formed about the inner cover layer. Either or both of the inner cover layer and the outer cover layer comprises a polyurethane material. The inner cover layer and the outer cover layer exhibit hardnesses which differ by at least five units as measured on the Shore D scale.

In yet another aspect, the present invention provides a golf ball comprising a unique construction as follows. The golf ball comprises a center core component which includes a polymeric material and at least one density increasing filler material that has a specific gravity in the range of from 1 to 20. The golf ball further comprises a core layer disposed about the center core component in which the core layer has a composition different than the center core component. The golf ball further includes an inner cover layer disposed on the core layer such that the inner cover layer has a thickness of from about 0.01 inches to about 0.10 inches. The golf ball further comprises an outer cover layer disposed on the inner cover layer wherein the outer cover layer has a thickness of from about 0.01 inches to about 0.10 inches. The outer cover layer comprises a polyurethane material. The golf ball further exhibits a feature in that the hardness differential between the inner cover layer and the outer cover layer is at least five units on the Shore D scale.

The present invention also provides a method of forming a golf ball as follows. The method comprises the steps of providing a density adjusting filler material. The method further includes providing a polymeric core material which is suitable for use in a golf ball core. The method also includes a step of mixing the density adjusting filler material and the polymeric core material and forming a center core component. The method includes providing a core layer material having a composition different than the composition of the center core component. A core layer is then formed from the core layer material about the center core component. The method also includes a step of providing an inner cover material and forming an inner cover layer from the inner cover material on the core layer. The method additionally includes a step of selecting a polyurethane material adapted for use in an outer cover layer such that upon curing the inner cover layer and the outer cover layer, the hardness differential between the inner cover layer and the outer cover layer is at least 5 on the Shore D scale. Further, the method also includes a step of forming an outer cover layer on the inner cover layer to thereby form the golf ball.

### BRIEF DESCRIPTION OF THE DRAWINGS

FIG. 1 is a cross-sectional view of a preferred embodiment golf ball in accordance with the present invention illustrating a core and a cover comprising an inner cover layer and an outer dimpled cover layer;

FIG. 2 is a partial sectional view of the preferred embodiment golf ball depicted in FIG. 1 having a core and a cover comprising an inner cover layer surrounding the core and an outer cover layer having a plurality of dimples;

FIG. 3 is a cross-sectional view of another preferred embodiment golf ball in accordance with the present invention comprising a dual core component;

FIG. 4 is a cross-sectional view of yet another preferred embodiment golf ball in accordance with the present invention comprising a dual core component;

FIG. 5 is a cross-sectional view of another preferred embodiment golf ball in accordance with the present invention comprising a dual core component and a multi-layer cover assembly;

FIG. 6 is a cross-sectional view of yet another preferred embodiment golf ball in accordance with the present invention comprising a dual core component and a multi-layer cover assembly.

### DETAILED DESCRIPTION OF THE PREFERRED EMBODIMENTS

The present invention is directed to a golf ball comprising a dual-core component and a single or multi-layer cover. The golf ball covers of the present invention comprise a high acid (greater than 16 weight percent acid) ionomer, a low acid (16 weight percent acid or less) ionomer, a blend of one or more ionomers (high acid and/or low acid), or one or more non-ionomeric thermoplastic or thermosetting elastomers or blends thereof, such as a polyurethane. The multi-layer cover assembly includes at least an inner cover layer and an outer cover layer. The multi-layer cover assembly could include additional layers. It is significant that each of the cover layers is compositionally different. The multi-layer golf balls of the present invention can be of standard or enlarged size. Preferably, the inner layer or ply includes a blend of ionomers and the outer cover layer is comprised of polyurethane. Preferably, the multi-layer cover assembly includes two cover layers. Preferably, each of the cover layers exhibits a particular Shore D hardness different than the hardness of the other layer. Most preferably, the difference in hardness between the inner cover layer and the outer cover layer is at least 5 on the Shore D scale.

The present invention golf balls also utilize a unique dual-core configuration. Preferably, the cores comprise (i) an interior spherical center component formed from a thermoset material, a thermoplastic material, or combinations thereof; and (ii) a core layer disposed about the spherical center component, the core layer formed from a thermoset material, a thermoplastic material, or combinations thereof. The cores may further comprise (iii) an optional outer core layer disposed about the core layer. The outer core layer may be formed from a thermoset material, a thermoplastic material, or combinations thereof. Preferably, the core center component is compositionally different than the core layer and, if an outer core layer is used, different than the composition of that outer layer. Most preferably, the core center component comprises a blend of two or more materials. And, in a particularly preferred embodiment, the core center component comprises one or more density-increasing materials dispersed throughout that component.

Although the present invention is primarily directed to golf balls comprising a dual core component and a multi-layer cover as described herein, the present invention also includes golf balls having a dual core component and conventional covers, such as single cover layers comprising balata, various thermoplastic materials, cast polyurethanes, or any other known cover materials. Similarly, the golf balls of the present invention may utilize a single core, i.e. not a dual core as generally described herein, in conjunction with the multi-layer cover assemblies described herein.

It has been found that multi-layer golf balls having inner and outer cover layers generally exhibit higher C.O.R. values and have greater travel distance in comparison with balls made from a single cover layer. In addition, it has been found that use of an inner cover layer constructed of a blend of low acid (i.e., 16 weight percent acid or less) ionomer resins produces softer compression and higher spin rates than inner cover layers constructed of high acid ionomer resins. This is compounded if a softer polyurethane outer layer is utilized. Such layer adds to the desirable “feel” and high spin rate while maintaining respectable resilience. The soft outer layer allows the cover to deform more during impact and increases the area of contact between the club face and the cover, thereby imparting more spin on the ball. As a result, the soft polyurethane cover provides the ball with a balata-like feel and playability characteristics with improved distance and durability.

Consequently, the overall combination of the unique dual core configuration, described in greater detail herein, and the multi-layer cover construction of inner and outer cover layers made, for example, from blends of ionomer resins and polyurethane, results in a standard size or oversized golf ball having enhanced resilience (improved travel distance) and durability (i.e. cut resistance, etc.) characteristics while maintaining and in many instances, improving the ball's playability properties.

The combination of an ionomeric inner cover layer with a soft, relatively low modulus ionomer, polyurethane based elastomer outer cover layer provides for good overall coefficient of restitution (i.e., enhanced resilience) while at the same time demonstrating improved compression and spin. The outer cover layer generally contributes to a more desirable feel and spin, particularly at lower swing speeds with highly lofted clubs such as half wedge shots.

Accordingly, the present invention is directed to a golf ball comprising a dual-core configuration and an improved multi-layer cover which produces, upon molding each layer around a core to formulate a multi-layer cover, a golf ball exhibiting enhanced distance (i.e., resilience) without adversely affecting, and in many instances, improving the ball's playability (hardness/softness) and/or durability (i.e., cut resistance, fatigue resistance, etc.) characteristics.

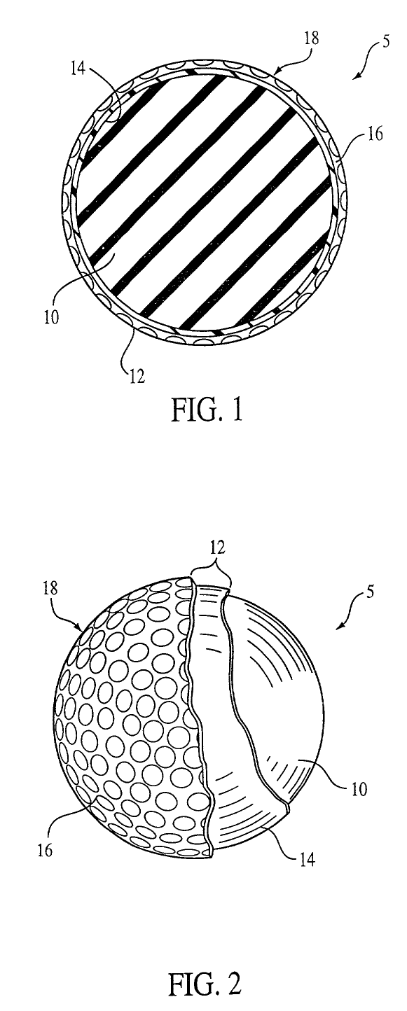

FIGS. 1 and 2 illustrate a preferred embodiment golf ball 5 in accordance with the present invention. It will be understood that none of the referenced figures are to scale. And so, the thicknesses and proportions of the various layers and the diameter of the various core and cover components are not necessarily as depicted. The golf ball 5 comprises a multi-layered cover 12 disposed about a core 10. The core 10 of the golf ball can be formed of a solid, a liquid, or any other substances that may be utilized to produce the cores described herein. The multi-layered cover 12 comprises two layers: a first or inner layer or ply 14 and a second or outer layer or ply 16. The inner layer 14 can be comprised of ionomer, ionomer blends, non-ionomer, non-ionomer blends, or blends of ionomer and non-ionomer. The outer layer 16 can be comprised of ionomer, ionomer blends, non-ionomer, non-ionomer blends or blends of ionomer and non-ionomer.

In a first preferred embodiment, the inner cover layer 14 is comprised of a high acid (i.e. greater than 16 weight percent acid) ionomer resin or high acid ionomer blend. Preferably, the inner cover layer is comprised of a blend of two or more high acid (i.e., at least 16 weight percent acid) ionomer resins neutralized to various extents by different metal cations. The inner cover layer may or may not include a metal stearate (e.g., zinc stearate) or other metal fatty acid salt. The purpose of the metal stearate or other metal fatty acid salt is to lower the cost of production without affecting the overall performance of the finished golf ball. In a second embodiment, the inner layer 14 is comprised of a low acid (i.e., 16 weight percent acid or less) ionomer blend. Preferably, the inner layer is comprised of a blend of two or more low acid (i.e., 16 weight percent acid or less) ionomer resins neutralized to various extents by different metal cations. The inner cover layer may or may not include a metal stearate (e.g., zinc stearate) or other metal fatty acid salt.

Two principal properties involved in golf ball performance are resilience and hardness. Resilience is determined by the coefficient of restitution (C.O.R.), the constant “e” which is the ratio of the relative velocity of two elastic spheres after direct impact to that before impact. As a result, the coefficient of restitution (“e”) can vary from 0 to 1, with 1 being equivalent to an elastic collision and 0 being equivalent to an inelastic collision.

Resilience (C.O.R.), along with additional factors such as club head speed, angle of trajectory and ball configuration (i.e., dimple pattern) generally determine the distance a ball will travel when hit. Since club head speed and the angle of trajectory are factors not easily controllable by a manufacturer, factors of concern among manufacturers are the coefficient of restitution (C.O.R.) and the surface configuration of the ball.

The coefficient of restitution (C.O.R.) in solid core balls is a function of the composition of the molded core and of the cover. In balls containing a dual core (i.e., balls comprising an interior spherical center component, a core layer disposed about the spherical center component, and a cover), the coefficient of restitution is a function of not only the composition of the cover, but also the composition and physical characteristics of the interior spherical center component and core layer. Both the dual core and the cover contribute to the coefficient of restitution in the golf balls of the present invention.

In this regard, the coefficient of restitution of a golf ball is generally measured by propelling a ball at a given speed against a hard surface and measuring the ball's incoming and outgoing velocities electronically. As mentioned above, the coefficient of restitution is the ratio of the outgoing velocity to the incoming velocity. The coefficient of restitution must be carefully controlled in all commercial golf balls in order for the ball to be within the specifications regulated by the United States Golf Association (U.S.G.A.) Along this line, the U.S.G.A. standards indicate that a “regulation” ball cannot have an initial velocity (i.e., the speed off the club) exceeding 255 feet per second. Since the coefficient of restitution of a ball is related to the ball's initial velocity, it is highly desirable to produce a ball having sufficiently high coefficient of restitution to closely approach the U.S.G.A. limit on initial velocity, while having an ample degree of softness (i.e., hardness) to produce enhanced playability (i.e., spin, etc.).

The hardness of the ball is the second principal property involved in the performance of a golf ball. The hardness of the ball can affect the playability of the ball on striking and the sound or “click” produced. Hardness is determined by the deformation (i.e., compression) of the ball under various load conditions applied across the ball's diameter (i.e., the lower the compression value, the harder the material). As indicated in U.S. Pat. No. 4,674,751, softer covers permit the accomplished golfer to impart proper spin. This is because the softer covers deform on impact significantly more than balls having “harder” ionomeric resin covers. As a result, the better player is allowed to impart fade, draw or backspin to the ball thereby enhancing playability. Such properties may be determined by various spin rate tests.

It will be appreciated that in accordance with the present invention, the outer cover layer is softer than the inner cover layer. However, the present invention includes embodiments in which the outer cover layer is harder than the inner cover layer. It is particularly preferred that regardless of the arrangement of hard and soft layers, that the difference in hardness between each of the cover layers is at least 5, as measured on the Shore D scale.

Inner Cover Layer

The inner cover layer generally has a thickness in the range of 0.01 to 0.10 inches, preferably 0.03 to 0.07 inches for a 1.68 inch ball and 0.05 to 0.10 inches for a 1.72 inch (or more) ball. The core and inner cover layer together form an inner ball having a coefficient of restitution of 0.780 or more and more preferably 0.790 or more, and a diameter in the range of 1.48-1.66 inches for a 1.68 inch ball and 1.50-1.70 inches for a 1.72 inch (or more) ball. Preferably, the inner cover layer has a Shore D hardness of 60 or more. It is particularly advantageous if the golf balls of the invention have an inner layer with a Shore D hardness of 65 or more. The above-described characteristics of the inner cover layer provide an intermediate ball having a PGA compression of 100 or less. It is found that when the intermediate ball has a PGA compression of 90 or less, excellent playability results.

The inner layer compositions may include the high acid ionomers such as those developed by E.I. DuPont de Nemours & Company under the trademark Surlyn® and by Exxon Corporation under the trademarks Escor®lotek®, or blends thereof. Examples of compositions which may be used as the inner layer herein are set forth in detail in a continuation of U.S. application Ser. No. 08/174,765, now abandoned, which is a continuation of U.S. application Ser. No. 07/776,803 filed Oct. 15, 1991, now abandoned, and Ser. No. 08/493,089, now U.S. Pat. No. 5,688,869, which is a continuation of Ser. No. 07/981,751, now abandoned, which in turn is a continuation of Ser. No. 07/901,660 filed Jun. 19, 1992, now abandoned, all of which are incorporated herein by reference. Of course, the inner layer high acid ionomer compositions are not limited in any way to those compositions set forth in said applications.

The high acid ionomers which may be suitable for use in formulating the inner layer compositions are ionic copolymers which are the metal, i.e., sodium, zinc, magnesium, etc., salts of the reaction product of an olefin having from about 2 to 8 carbon atoms and an unsaturated monocarboxylic acid having from about 3 to 8 carbon atoms. Preferably, the ionomeric resins are copolymers of ethylene and either acrylic or methacrylic acid. In some circumstances, an additional comonomer such as an acrylate ester (i.e., iso- or n-butylacrylate, etc.) can also be included to produce a softer terpolymer. The carboxylic acid groups of the copolymer are partially neutralized (i.e., approximately 10-100%, preferably 30-70%) by the metal ions. Each of the high acid ionomer resins which may be included in the inner layer cover compositions of the invention contains more than about 16% by weight of a carboxylic acid, preferably from about 17% to about 25% by weight of a carboxylic acid, and more preferably from about 18.5% to about 21.5% by weight of a carboxylic acid.

Although the inner layer cover composition of several embodiments of the present invention preferably includes a high acid ionomeric resin, the scope of the patent embraces all known high acid ionomeric resins falling within the parameters set forth above. Only a relatively limited number of these high acid ionomeric resins have recently become commercially available.

The high acid ionomeric resins available from Exxon under the designation Escor® and or lotek® are somewhat similar to the high acid ionomeric resins available under the Surlyn® trademark. However, since the Escor®/lotek® ionomeric resins are sodium or zinc salts of poly(ethylene-acrylic acid) and the Surlyn® resins are zinc, sodium, magnesium, etc. salts of poly(ethylene-methacrylic acid), distinct differences in properties exist.

Examples of the high acid methacrylic acid based ionomers found suitable for use in accordance with this invention include Surlyn® 8220 and 8240 (both formerly known as forms of Surlyn® AD-8422), Surlyn® 9220 (zinc cation), Surlyn® SEP-503-1 (zinc cation), and Surlyn® SEP-503-2 (magnesium cation). According to DuPont, all of these ionomers contain from about 18.5 to about 21.5% by weight methacrylic acid.

More particularly, Surlyn® AD-8422 is currently commercially available from DuPont in a number of different grades (i.e., AD-8422-2, AD-8422-3, AD-8422-5, etc.) based upon differences in melt index. According to DuPont, Surlyn® 8422, which is believed recently to have been redesignated as 8220 and 8240, offers the following general properties when compared to Surlyn® 8920, the stiffest, hardest of all on the low acid grades (referred to as “hard” ionomers in U.S. Pat. No. 4,884,814). See Table 1 below.

TABLE 1

| | LOW ACID | HIGH ACID | |
|---|---|---|---|
| | (15 wt % Acid) | (>20 wt % Acid) | |
| | SURLYN ® | SURLYN ® | SURLYN ® |
| | 8920 | 8422-2 | 8422-3 |
| IONOMER | | | |
| Cation | Na | Na | Na |
| Melt Index | 1.2 | 2.8 | 1.0 |
| Sodium, Wt % | 2.3 | 1.9 | 2.4 |
| Base Resin MI | 60 | 60 | 60 |
| MP¹, ° C. | 88 | 86 | 85 |
| FP¹, ° C. | 47 | 48.5 | 45 |
| COMPRESSION | | | |
| MOLDING² | | | |
| Tensile Break, | 4350 | 4190 | 5330 |
| psi | | | |
| Yield, psi | 2880 | 3670 | 3590 |
| Elongation, % | 315 | 263 | 289 |
| Flex Mod, | 53.2 | 76.4 | 88.3 |
| K psi | | | |
| Shore D | 66 | 67 | 68 |
| hardness | | | |

¹DSC second heat, 10° C./min heating rate.
²Samples compression molded at 150° C. annealed 24 hours at 60° C. 8422-2, -3 were homogenized at 190° C. before molding.

In comparing Surlyn® 8920 to Surlyn® 8422-2 and Surlyn® 8422-3, it is noted that the high acid Surlyn® 8422-2 and 8422-3 ionomers have a higher tensile yield, lower elongation, slightly higher Shore D hardness and much higher flexural modulus. Surlyn® 8920 contains 15 weight percent methacrylic acid and is 59% neutralized with sodium.

In addition, Surlyne® SEP-503-1 (zinc cation) and Surlyn® SEP-503-2 (magnesium cation) are high acid zinc and magnesium versions of the Surlyn® AD 8422 high acid ionomers. When compared to the Surlyn® AD 8422 high acid ionomers, the Surlyn® SEP-503-1 and SEP-503-2 ionomers can be defined as follows, See Table 2.

TABLE 2

| Surlyn ® Ionomer | Ion | Melt Index | Neutralization % |
|---|---|---|---|
| AD 8422-3 | Na | 1.0 | 45 |
| SEP 503-1 | Zn | 0.8 | 38 |
| SEP 503-2 | Mg | 1.8 | 43 |

Further, Surlyn® 8162 is a zinc cation ionomer resin containing approximately 20% by weight (i.e., 18.5-21.5% weight) methacrylic acid copolymer that has been 30-70% neutralized. Surlyn® 8162 is currently commercially available from DuPont.

Examples of the high acid acrylic acid based ionomers suitable for use in the present invention also include the Escor® or lotek® high acid ethylene acrylic acid ionomers produced by Exxon such as Ex 1001, 1002, 959, 960, 989, 990, 1003, 1004, 993, 994. In this regard, Escor® or lotek® 959 is a sodium ion neutralized ethylene-acrylic neutralized ethylene-acrylic acid copolymer. According to Exxon, lotek® 959 and 960 contain from about 19.0 to 21.0% by weight acrylic acid with approximately 30 to about 70 percent of the acid groups neutralized with sodium and zinc ions, respectively. The physical properties of these high acid acrylic acid based ionomers are set forth in Tables 3 and 4 as follows:

TABLE 3
Physical Properties of Various Ionomers

| | | | ESCOR ® | | | ESCOR ® |
|---|---|---|---|---|---|---|
| | Ex | Ex | (IOTEK) ® | Ex | Ex | (IOTEK) ® |
| PROPERTY | 1001 | 1002 | 959 | 1003 | 1004 | 960 |
| Melt index, | 1.0 | 1.6 | 2.0 | 1.1 | 2.0 | 1.8 |
| g/10 min | | | | | | |
| Cation | Na | Na | Na | Zn | Zn | Zn |
| Melting | 183 | 183 | 172 | 180 | 180.5 | 174 |
| Point, ° F. | | | | | | |
| Vicat | 125 | 125 | 130 | 133 | 131 | 131 |
| Softening | | | | | | |
| Point, ° F. | | | | | | |
| Tensile | 34.4 | 22.5 | 4600 | 24.8 | 20.6 | 3500 |
| @ Break | MPa | MPa | psi | MPa | MPa | psi |
| Elongation | 341 | 348 | 325 | 387 | 437 | 430 |
| @ Break, % | | | | | | |
| Hardness, | 63 | 62 | 66 | 54 | 53 | 57 |
| Shore D | | | | | | |
| Flexural | 365 | 380 | 66,000 | 147 | 130 | 27,000 |
| Modulus | MPa | MPa | psi | MPa | MPa | psi |

TABLE 4
Physical Properties of Various Ionomers

| | EX 989 | EX 993 | EX 994 | EX 990 | |
|---|---|---|---|---|---|
| Melt index | g/10 min | 1.30 | 1.25 | 1.32 | 1.24 |
| Moisture | ppm | 482 | 214 | 997 | 654 |
| Cation type | — | Na | Li | K | Zn |
| M+ content by AAS | wt % | 2.74 | 0.87 | 4.54 | 0 |
| Zn content by AAS | wt % | 0 | 0 | 0 | 3.16 |
| Density | kg/m³ | 959 | 945 | 976 | 977 |
| Vicat softening point | ° C. | 52.5 | 51 | 50 | 55.0 |
| Crystallization point | ° C. | 40.1 | 39.8 | 44.9 | 54.4 |
| Melting point | ° C. | 82.6 | 81.0 | 80.4 | 81.0 |
| Tensile at yield | MPa | 23.8 | 24.6 | 22 | 16.5 |
| Tensile at break | MPa | 32.3 | 31.1 | 29.7 | 23.8 |
| Elongation at break | % | 330 | 260 | 340 | 357 |
| 1% secant modulus | MPa | 389 | 379 | 312 | 205 |
| Flexural modulus | MPa | 340 | 368 | 303 | 183 |
| Abrasion resistance | mg | 20.0 | 9.2 | 15.2 | 20.5 |
| Hardness Shore D | — | 62 | 62.5 | 61 | 58 |
| Zwick Rebound | % | 61 | 63 | 59 | 48 |

Furthermore, as a result of the development by the assignee of this application of a number of new high acid ionomers neutralized to various extents by several different types of metal cations, such as by manganese, lithium, potassium, calcium and nickel cations, several new high acid ionomers and/or high acid ionomer blends besides sodium, zinc and magnesium high acid ionomers or ionomer blends are now available for golf ball cover production. It has been found that these new cation neutralized high acid ionomer blends produce inner cover layer compositions exhibiting enhanced hardness and resilience due to synergies which occur during processing.

Consequently, the metal cation neutralized high acid ionomer resins recently produced can be blended to produce substantially higher C.O.R.'s than those produced by the low acid ionomer inner cover compositions presently commercially available.

More particularly, several new metal cation neutralized high acid ionomer resins have been produced by the inventors by neutralizing, to various extents, high acid copolymers of an alpha-olefin and an alpha, beta-unsaturated carboxylic acid with a wide variety of different metal cation salts. This discovery is the subject matter of U.S. application Ser. No. 08/493,089, now U.S. Pat. No. 5,688,869, incorporated herein by reference. It has been found that numerous new metal cation neutralized high acid ionomer resins can be obtained by reacting a high acid copolymer (i.e., a copolymer containing greater than 16% by weight acid, preferably from about 17 to about 25 weight percent acid, and more preferably about 20 weight percent acid), with a metal cation salt capable of ionizing or neutralizing the copolymer to the extent desired (i.e., from about 10% to 90%).

The base copolymer is made up of greater than 16% by weight of an alpha, beta-unsaturated carboxylic acid and an alpha-olefin. Optionally, a softening comonomer can be included in the copolymer. Generally, the alpha-olefin has from 2 to 10 carbon atoms and is preferably ethylene, and the unsaturated carboxylic acid is a carboxylic acid having from about 3 to 8 carbons. Examples of such acids include acrylic acid, methacrylic acid, ethacrylic acid, chloroacrylic acid, crotonic acid, maleic acid, fumaric acid, and itaconic acid, with acrylic acid being preferred.

The softening comonomer that can be optionally included in the inner cover layer for the golf ball of the invention may be selected from the group consisting of vinyl esters of aliphatic carboxylic acids wherein the acids have 2 to 10 carbon atoms, vinyl ethers wherein the alkyl groups contain 1 to 10 carbon atoms, and alkyl acrylates or methacrylates wherein the alkyl groups contain 1 to 10 carbon atoms. Suitable softening comonomers include vinyl acetate, methyl acrylate, methyl methacrylate, ethyl acrylate, ethyl methacrylate, butyl acrylate, butyl methacrylate, or the like.

Consequently, examples of a number of copolymers suitable for use to produce the high acid ionomers included in the present invention include, but are not limited to, high acid embodiments of an ethylene/acrylic acid copolymer, an ethylene/methacrylic acid copolymer, an ethylene/itaconic acid copolymer, an ethylene/maleic acid copolymer, an ethylene/methacrylic acid/vinyl acetate copolymer, an ethylene/acrylic acid/vinyl alcohol copolymer, etc. The base copolymer broadly contains greater than 16% by weight unsaturated carboxylic acid, from about 39 to about 83% by weight ethylene and from 0 to about 40% by weight of a softening comonomer. Preferably, the copolymer contains about 20% by weight unsaturated carboxylic acid and about 80% by weight ethylene. Most preferably, the copolymer contains about 20% acrylic acid with the remainder being ethylene.

Along these lines, examples of the preferred high acid base copolymers which fulfill the criteria set forth above, are a series of ethylene-acrylic copolymers which are commercially available from The Dow Chemical Company, Midland, Mich., under the Primacor® designation. These high acid base copolymers exhibit the typical properties set forth below in Table 5.

TABLE 5
Typical Properties of Primacor ®
Ethylene-Acrylic Acid Copolymers

| | | | | | FLEXURAL | VICAT | |
|---|---|---|---|---|---|---|---|
| | PERCENT | DENSITY, | MELT INDEX, | TENSILE | MODULUS | SOFT PT | SHORE D |
| GRADE | ACID | glcc | g/10 min | YD ST (psi) | (psi) | (° C.) | HARDNESS |
| ASTM | | D-792 | D-1238 | D-638 | D-790 | D-1525 | D-2240 |
| 5980 | 20.0 | 0.958 | 300.0 | — | 4800 | 43 | 50 |
| 5990 | 20.0 | 0.955 | 1300 0 | 650 | 3200 | 40 | 42 |
| 5981 | 20.0 | 0.960 | 300.0 | 900 | 3200 | 46 | 48 |
| 5983 | 20.0 | 0.958 | 500 0 | 850 | 3100 | 44 | 45 |
| 5991 | 20.0 | 0 953 | 2600 0 | 635 | 2600 | 36 | 40 |

¹The Melt Index values are obtained according to ASTM D-1238, at 190° C.

Due to the high molecular weight of the Primacor® 5981 grade of the ethylene-acrylic acid copolymer, this copolymer is the more preferred grade utilized in the invention.

The metal cation salts utilized in the invention are those salts which provide the metal cations capable of neutralizing, to various extents, the carboxylic acid groups of the high acid copolymer. These include acetate, oxide or hydroxide salts of lithium, calcium, zinc, sodium, potassium, nickel, magnesium, and manganese.

Examples of such lithium ion sources are lithium hydroxide monohydrate, lithium hydroxide, lithium oxide and lithium acetate. Sources for the calcium ion include calcium hydroxide, calcium acetate and calcium oxide. suitable zinc ion sources are zinc acetate dihydrate and zinc acetate, a blend of zinc oxide and acetic acid. Examples of sodium ion sources are sodium hydroxide and sodium acetate. Sources for the potassium ion include potassium hydroxide and potassium acetate. Suitable nickel ion sources are nickel acetate, nickel oxide and nickel hydroxide. Sources of magnesium include magnesium oxide, magnesium hydroxide and magnesium acetate. Sources of manganese include manganese acetate and manganese oxide.

The new metal cation neutralized high acid ionomer resins are produced by reacting the high acid base copolymer with various amounts of the metal cation salts above the crystalline melting point of the copolymer, such as at a temperature from about 200° F. to about 500° F., preferably from about 250° F. to about 350° F. under high shear conditions at a pressure of from about 10 psi to 10,000 psi. Other well known blending techniques may also be used. The amount of metal cation salt utilized to produce the new metal cation neutralized high acid based ionomer resins is the quantity which provides a sufficient amount of the metal cations to neutralize the desired percentage of the carboxylic acid groups in the high acid copolymer. The extent of neutralization is generally from about 10% to about 90%.

As indicated below in Table 6 and more specifically in Example 1 in U.S. application Ser. No. 08/493,089, now U.S. Pat. No. 5,688,869, a number of new types of metal cation neutralized high acid ionomers can be obtained from the above indicated process. These include new high acid ionomer resins neutralized to various extents with manganese, lithium, potassium, calcium and nickel cations. In addition, when a high acid ethylene/acrylic acid copolymer is utilized as the base copolymer component of the invention and this component is subsequently neutralized to various extents with the metal cation salts producing acrylic acid based high acid ionomer resins neutralized with cations such as sodium, potassium, lithium, zinc, magnesium, manganese, calcium and nickel, several new cation neutralized acrylic acid based high acid ionomer resins are produced.

TABLE 6
Metal Cation Neutralized High Acid Ionomers

| | Wt-% | | | | |
|---|---|---|---|---|---|
| | Cation | Wt-% | Melt | | Shore D |
| Formulation No. | Salt | Neutralization | Index | C.O.R. | Hardness |
| 1 (NaOH) | 6.98 | 67.5 | 0.9 | .804 | 71 |
| 2 (NaOH) | 5.68 | 54.0 | 2.4 | .808 | 73 |
| 3 (NaOH) | 3.84 | 35.9 | 12.2 | .812 | 69 |
| 4 (NaOH) | 2.91 | 27.0 | 17.5 | .812 | (brittle) |
| 5 (MnAc) | 19.6 | 71.7 | 7.5 | .809 | 73 |
| 6 (MnAc) | 23.1 | 88.3 | 3.5 | .814 | 77 |
| 7 (MnAc) | 15.3 | 53.0 | 7.5 | .810 | 72 |
| 8 (MnAc) | 26.5 | 106 | 0.7 | .813 | (brittle) |
| 9 (LiOH) | 4.54 | 71.3 | 0.6 | .810 | 74 |
| 10 (LiOH) | 3.38 | 52.5 | 4.2 | .818 | 72 |
| 11 (LiOH) | 2.34 | 35.9 | 18.6 | .815 | 72 |
| 12 (KOH) | 5.30 | 36.0 | 19.3 | Broke | 70 |
| 13 (KOH) | 8.26 | 57.9 | 7.18 | .804 | 70 |
| 14 (KOH) | 10.7 | 77.0 | 4.3 | .801 | 67 |
| 15 (ZnAc) | 17.9 | 71.5 | 0.2 | .806 | 71 |
| 16 (ZnAc) | 13.9 | 53.0 | 0.9 | .797 | 69 |
| 17 (ZnAc) | 9.91 | 36.1 | 3.4 | .793 | 67 |
| 18 (MgAc) | 17.4 | 70.7 | 2.8 | .814 | 74 |
| 19 (MgAc) | 20.6 | 87.1 | 1.5 | .815 | 76 |
| 20 (MgAc) | 13.8 | 53.8 | 4.1 | .814 | 74 |
| 21 (CaAc) | 13.2 | 69.2 | 1.1 | .813 | 74 |
| 22 (CaAc) | 7.12 | 34.9 | 10.1 | .808 | 70 |
| 23 (MgO) | 2.91 | 53.5 | 2.5 | .813 | |
| 24 (MgO) | 3.85 | 71.5 | 2.8 | .808 | |
| 25 (MgO) | 4.76 | 89.3 | 1.1 | .809 | |
| 26 (MgO) | 1.96 | 35.7 | 7.5 | .815 | |
| 27 (NiAc) | 13.04 | 61.1 | 0.2 | .802 | 71 |
| 28 (NiAc) | 10.71 | 48.9 | 0.5 | .799 | 72 |
| 29 (NiAc) | 8.26 | 36.7 | 1.8 | .796 | 69 |
| 30 (NiAc) | 5.66 | 24.4 | 7.5 | .786 | 64 |

Controls:
50/50 Blend of Iotek ®s 8000/7030 C.O.R. = .810/65 Shore D Hardness
DuPont High Acid Surlyn ® 8422 (Na) C.O.R. = .811/70 Shore D Hardness
DuPont High Acid Surlyn ® 8162 (Zn) C.O.R. = .807/65 Shore D Hardness
Exxon High Acid Iotek ® EX-960 (Zn) C.O.R. = .796/65 Shore D Hardness
Control for Formulations 23-26 is 50/50 Iotek ® 8000/7030, C.O.R. = .814, Formulation 26 C.O.R. was normalized to that control accordingly
Control for Formulation Nos. 27-30 is 50/50 Iotek ® 8000/7030, C.O.R. = .807

When compared to low acid versions of similar cation neutralized ionomer resins, the new metal cation neutralized high acid ionomer resins exhibit enhanced hardness, modulus and resilience characteristics. These are properties that are particularly desirable in a number of thermoplastic fields, including the field of golf ball manufacturing.

When utilized in the construction of the inner layer of a multi-layered golf ball, it has been found that the new acrylic acid based high acid ionomers extend the range of hardness beyond that previously obtainable while maintaining the beneficial properties (i.e. durability, click, feel, etc.) of the softer low acid ionomer covered balls, such as balls produced utilizing the low acid ionomers disclosed in U.S. Pat. Nos. 4,884,814 and 4,911,451.

Moreover, as a result of the development of a number of new acrylic acid based high acid ionomer resins neutralized to various extents by several different types of metal cations, such as manganese, lithium, potassium, calcium and nickel cations, several new ionomers or ionomer blends are now available for production of an inner cover layer of a multi-layered golf ball. By using these high acid ionomer resins, harder, stiffer inner cover layers having higher C.O.R.s, and thus longer distance, can be obtained.

More preferably, it has been found that when two or more of the above-indicated high acid ionomers, particularly blends of sodium and zinc high acid ionomers, are processed to produce the covers of multi-layered golf balls, (i.e., the inner cover layer herein) the resulting golf balls will travel further than previously known multi-layered golf balls produced with low acid ionomer resin covers due to the balls' enhanced coefficient of restitution values.

The low acid ionomers which may be suitable for use in formulating the inner layer compositions of several of the embodiments of the subject invention are ionic copolymers which are the metal, i.e., sodium, zinc, magnesium, etc., salts of the reaction product of an olefin having from about 2 to 8 carbon atoms and an unsaturated monocarboxylic acid having from about 3 to 8 carbon atoms. Preferably, the ionomeric resins are copolymers of ethylene and either acrylic or methacrylic acid. In some circumstances, an additional comonomer such as an acrylate ester (i.e., iso- or n-butylacrylate, etc.) can also be included to produce a softer terpolymer. The carboxylic acid groups of the copolymer are partially neutralized (i.e., approximately 10-100%, preferably 30-70%) by the metal ions. Each of the low acid ionomer resins which may be included in the inner layer cover compositions of the invention contains 16% by weight or less of a carboxylic acid.

The inner layer compositions include the low acid ionomers such as those developed and sold by E.I. DuPont de Nemours & Company under the trademark Surlyn® and by Exxon Corporation under the trademarks Escor® lotek®, or blends thereof.

The low acid ionomer resins available from Exxon under the designation Escor® and/or lotek®, are somewhat similar to the low acid ionomeric resins available under the Surlyn® trademark. However, since the Escor®/lotek® ionomeric resins are sodium or zinc salts of poly(ethylene-acrylic acid) and the Surlyn® resins are zinc, sodium, magnesium, etc. salts of poly(ethylene-methacrylic acid), distinct differences in properties exist.

When utilized in the construction of the inner layer of a multi-layered golf ball, it has been found that the low acid ionomer blends extend the range of compression and spin rates beyond that previously obtainable. More preferably, it has been found that when two or more low acid ionomers, particularly blends of sodium and zinc ionomers, are processed to produce the covers of multi-layered golf balls, (i.e., the inner cover layer herein) the resulting golf balls will travel further and at an enhanced spin rate than previously known multi-layered golf balls. Such an improvement is particularly noticeable in enlarged or oversized golf balls.

The use of an inner layer formulated from blends of lower acid ionomers produces multi-layer golf balls having enhanced compression and spin rates. These are the properties desired by the more skilled golfer.

In yet another embodiment of the inner cover layer, a blend of high and low acid ionomer resins is used. These can be the ionomer resins described above, combined in a weight ratio which preferably is within the range of 10:90 to 90:10 parts of high and low acid ionomer resins.

A further additional embodiment of the inner cover layer is primarily based upon the use of a fully non-ionomeric thermoplastic or thermoset material. Suitable non-ionomeric materials include metallocene catalyzed polyolefins or polyamides, polyamide/ionomer blends, polyphenylene ether/ionomer blends, etc., which have a Shore D hardness of at least 60 and a flex modulus of greater than about 30,000 psi, or other hardness and flex modulus values which are comparable to the properties of the ionomers described above. Other suitable materials include but are not limited to thermoplastic or thermosetting polyurethanes, a polyester elastomer such as that marketed by DuPont under the trademark Hytrel®, or a polyether amide such as that marketed by Elf Atochem S.A. under the trademark Pebax®, a blend of two or more non-ionomeric thermoplastic elastomers, or a blend of one or more ionomers and one or more non-ionomeric thermoplastic elastomers. These materials can be blended with the ionomers described above in order to reduce cost relative to the use of higher quantities of ionomer.

Outer Cover Layer

While the dual core component described below, and the hard inner cover layer formed thereon, provide the multi-layer golf ball with power and distance, the outer cover layer 16 illustrated in FIGS. 1 and 2 is comparatively softer than the inner cover layer. The softness provides for the feel and playability characteristics typically associated with balata or balata-blend balls. The outer cover layer or ply is comprised of a relatively soft, low modulus (about 1,000 psi to about 10,100 psi) and, in an alternate embodiment, low acid (less than 16 weight percent acid) ionomer, an ionomer blend, a non-ionomeric thermoplastic or thermosetting material such as, but not limited to, a metallocene catalyzed polyolefin such as Exacts material available from Exxon, a polyurethane, a polyester elastomer such as that marketed by DuPont under the trademark Hytrel®, or a polyether amide such as that marketed by Elf Atochem S.A. under the trademark Pebax®, a blend of two or more non-ionomeric thermoplastic or thermosetting materials, or a blend of one or more ionomers and one or more non-ionomeric thermoplastic materials. It will be appreciated that the outer cover layer may also be relatively hard. In particular, it is preferred that the outer cover layer differ in hardness from the softer cover layer by at least 5 units on the Shore D hardness scale. In the event that the outer cover layer is hard, it is preferred that the inner cover layer be relatively soft.

Preferably, the outer layer is fairly thin (i.e. from about 0.010 to about 0.10 inches in thickness, more desirably 0.03 to 0.06 inches in thickness for a 1.680 inch ball and 0.04 to 0.07 inches in thickness for a 1.72 inch or more ball), but thick enough to achieve desired playability characteristics while minimizing expense. Thickness is defined as the average thickness of the non-dimpled areas of the outer cover layer. The outer cover layer, such as layer 16 in FIGS. 1 and 2, has a Shore D hardness of 55 or less, and more preferably 50 or less.

In one embodiment, the outer cover layer preferably is formed from an ionomer which constitutes at least 75 weight % of an acrylate ester-containing ionic copolymer or blend of acrylate ester-containing ionic copolymers. This type of outer cover layer in combination with the core and inner cover layer described above results in golf ball covers having a favorable combination of durability and spin rate. The one or more acrylate ester-containing ionic copolymers each contain an olefin, an acrylate ester, and an acid. In a blend of two or more acrylate ester-containing ionic copolymers, each copolymer may contain the same or a different olefin, acrylate ester and acid than are contained in the other copolymers. Preferably, the acrylate ester-containing ionic copolymer or copolymers are terpolymers, but additional monomers can be combined into the copolymers if the monomers do not substantially reduce the scuff resistance or other good playability properties of the cover.

For a given copolymer, the olefin is selected from the group consisting of olefins having 2 to 8 carbon atoms, including, as non-limiting examples, ethylene, propylene, butene-1, hexene-1 and the like. Preferably the olefin is ethylene.

The acrylate ester is an unsaturated monomer having from 1 to 21 carbon atoms which serves as a softening comonomer. The acrylate ester preferably is methyl, ethyl, n-propyl, n-butyl, n-octyl, 2-ethylhexyl, or 2-methoxyethyl 1-acrylate, and most preferably is methyl acrylate or n-butyl acrylate. Another suitable type of softening comonomer is an alkyl vinyl ether selected from the group consisting of n-butyl, n-hexyl, 2-ethylhexyl, and 2-methoxyethyl vinyl ethers.

The acid is a mono- or dicarboxylic acid and preferably is selected from the group consisting of methacrylic, acrylic, ethacrylic, chloroacrylic, crotonic, maleic, fumaric, and itaconic acid, or the like, and half esters of maleic, fumaric and itaconic acid, or the like. The acid group of the copolymer is 10-100% neutralized with any suitable cation, for example, zinc, sodium, magnesium, lithium, potassium, calcium, manganese, nickel, chromium, tin, aluminum, or the like. It has been found that particularly good results are obtained when the neutralization level is about 50-100%.

The one or more acrylate ester-containing ionic copolymers each has an individual Shore D hardness of about 5-64. The overall Shore D hardness of the outer cover is 55 or less, and generally is 40-55. It is preferred that the overall Shore D hardness of the outer cover is in the range of 40-50 in order to impart particularly good playability characteristics to the ball.

The outer cover layer of the invention is formed over a core or core assembly with an inner cover layer formed thereon, to result in a golf ball having a coefficient of restitution of at least 0.770, more preferably at least 0.780, and most preferably at least 0.790. The coefficient of restitution of the ball will depend upon the properties of both the core and the cover. The PGA compression of the golf ball is 100 or less, and preferably is 90 or less.

The acrylate ester-containing ionic copolymer or copolymers used in the outer cover layer can be obtained by neutralizing commercially available acrylate ester-containing acid copolymers such as polyethylene-methyl acrylate-acrylic acid terpolymers, including Escor® ATX (Exxon Chemical Company) or poly (ethylene-butyl acrylate-methacrylic acid) terpolymers, including Nucrel® (DuPont Chemical Company). Particularly preferred commercially available materials include ATX 320, ATX 325, ATX 310, ATX 350, and blends of these materials with Nucrel® 010 and Nucrel® 035. The acid groups of these materials and blends are neutralized with one or more of various cation salts including zinc, sodium, magnesium, lithium, potassium, calcium, manganese, nickel, etc. The degree of neutralization ranges from 10-100%. Generally, a higher degree of neutralization results in a harder and tougher cover material. The properties of non-limiting examples of commercially available unneutralized acid terpolymers which can be used to form the golf ball outer cover layers of the invention are provided below in Table 7.

TABLE 7
Properties of Unneutralized Acid Terpolymers

| | Melt Index | | Flex Modulus | |
|---|---|---|---|---|
| | dg/min | Acid No. | MPa | Hardness |
| Trade Name | ASTM D 1238 | % KOH/g | (ASTM D790) | (Shore D) |
| ATX 310 | 6 | 45 | 80 | 44 |
| ATX 320 | 5 | 45 | 50 | 34 |
| ATX 325 | 20 | 45 | 9 | 30 |
| ATX 350 | 6 | 15 | 20 | 28 |
| Nucrel ® 010 | 11 | 60 | 40 | 40 |
| Nucrel ® 035 | 35 | 60 | 59 | 40 |

The ionomer resins used to form the outer cover layers can be produced by reacting the acrylate ester-containing acid copolymer with various amounts of the metal cation salts at a temperature above the crystalline melting point of the copolymer, such as a temperature from about 200° F. to about 500° F., preferably from about 250° F. to about 350° F., under high shear conditions at a pressure of from about 100 psi to 10,000 psi. Other well known blending techniques may also be used. The amount of metal cation salt utilized to produce the neutralized ionic copolymers is the quantity which provides a sufficient amount of the metal cations to neutralize the desired percentage of the carboxylic acid groups in the high acid copolymer. When two or more different copolymers are to be used, the copolymers can be blended before or after neutralization. Generally, it is preferable to blend the copolymers before they are neutralized to provide for optimal mixing.

The compatibility of the acrylate ester-containing copolymers with each other in a copolymer blend produces a golf ball outer cover layer having a surprisingly good scuff resistance for a given hardness of the outer cover layer. The golf ball according to the invention has a scuff resistance of no higher than 3.0. It is preferred that the golf ball has a scuff resistance of no higher than about 2.5 to ensure that the golf ball is scuff resistant when used in conjunction with a variety of types of clubs, including sharp-grooved irons, which are particularly inclined to result in scuffing of golf ball covers. The best results according to the invention are obtained when the outer cover layer has a scuff resistance of no more than about 2.0.

Additional materials may also be added to the inner and outer cover layer of the present invention as long as they do not substantially reduce the playability properties of the ball. Such materials include dyes (for example, Ultramarine Blue™ sold by Whitaker, Clark, and Daniels of South Plainsfield, N.J.) (see U.S. Pat. No. 4,679,795), pigments such as titanium dioxide, zinc oxide, barium sulfate and zinc sulfate; UV absorbers; antioxidants; antistatic agents; and stabilizers. Moreover, the cover compositions of the present invention may also contain softening agents such as those disclosed in U.S. Pat. Nos. 5,312,857 and 5,306,760, including plasticizers, metal stearates, processing acids, etc., and reinforcing materials such as glass fibers and inorganic fillers, as long as the desired properties produced by the golf ball covers of the invention are not impaired.

The outer cover layer in another embodiment of the invention includes a blend of a soft (low acid) ionomer resin with a small amount of a hard (high acid) ionomer resin. A low modulus ionomer suitable for use in the outer layer blend has a flexural modulus measuring from about 1,000 to about 10,000 psi, with a hardness of about 20 to about 40 on the Shore D scale. A high modulus ionomer herein is one which measures from about 15,000 to about 70,000 psi as measured in accordance with ASTM method D-790. The hardness may be defined as at least 50 on the Shore D scale as measured in accordance with ASTM method D-2240.

Soft ionomers primarily are used in formulating the hard/soft blends of the cover compositions. These ionomers include acrylic acid and methacrylic acid based soft ionomers. They are generally characterized as comprising sodium, zinc, or other mono- or divalent metal cation salts of a terpolymer of an olefin having from about 2 to 8 carbon atoms, methacrylic acid, acrylic acid, or another, alpha, beta-unsaturated carboxylic acid, and an unsaturated monomer of the acrylate ester class having from 1 to 21 carbon atoms. The soft ionomer is preferably made from an acrylic acid base polymer is an unsaturated monomer of the acrylate ester class.

Certain ethylene-acrylic acid based soft ionomer resins developed by the Exxon Corporation under the designation lotek® 7520 (referred to experimentally by differences in neutralization and melt indexes as LDX 195, LDX 196, LDX 218 and LDX 219) may be combined with known hard ionomers such as those indicated above to produce the inner and outer cover layers. The combination produces higher C.O.R.s at equal or softer hardness, higher melt flow (which corresponds to improved, more efficient molding, i.e., fewer rejects) as well as significant cost savings versus the outer layer of multi-layer balls produced by other known hard-soft ionomer blends as a result of the lower overall raw materials cost and improved yields.

While the exact chemical composition of the resins to be sold by Exxon under the designation lotek® 7520 is considered by Exxon to be confidential and proprietary information, Exxon's experimental product data sheet lists the following physical properties of the ethylene acrylic acid zinc ionomer developed by Exxon:

TABLE 8

| Property Value | ASTM Method | Units | Typical |
|---|---|---|---|
| Physical Properties of Iotek ® 7520 | | | |
| Melt Index | D-1238 | g/10 min. | 2 |
| Density | D-1505 | kg/m³ | 0.962 |
| Cation | | | Zinc |
| Melting Point | D-3417 | ° C. | 66 |
| Crystallization | D-3417 | ° C. | 49 |
| Point | | | |
| Vicat Softening | D-1525 | ° C. | 42 |
| Point | | | |
| Plaque Properties (2 mm thick Compression Molded Plaques) | | | |
| Tensile at Break | D-638 | MPa | 10 |
| Yield Point | D-638 | MPa | None |
| Elongation at Break | D-638 | % | 760 |
| 1% Secant Modulus | D-638 | MPa | 22 |
| Shore D Hardness | D-2240 | | 32 |
| Flexural Modulus | D-790 | Mpa | 26 |
| Zwick Rebound | ISO 4862 | % | 52 |
| De Mattia Flex | D-430 | Cycles | >5000 |
| Resistance | | | |

In addition, test data collected by the inventors indicates that lotek® 7520 resins have Shore D hardnesses of about 32 to 36 (per ASTM D-2240), melt flow indexes of 3±0.5 g/l 0 min (at 190° C. per ASTM D-1288), and a flexural modulus of about 2500-3500 psi (per ASTM D-790). Furthermore, testing by an independent testing laboratory by pyrolysis mass spectrometry indicates at lotek® 7520 resins are generally zinc salts of a terpolymer of ethylene, acrylic acid, and methyl acrylate.

Furthermore, the inventors have found that a grade of an acrylic acid based soft ionomer available from the Exxon Corporation under the designation lotek® 7510 is also effective when combined with the hard ionomers indicated above in producing golf ball covers exhibiting higher C.O.R. values at equal or softer hardness than those produced by known hard-soft ionomer blends. In this regard, lotek® 7510 has the advantages (i.e. improved flow, higher C.O.R. values at equal hardness, increased clarity, etc.) produced by the lotek® 7520 resin when compared to the methacrylic acid base soft ionomers known in the art (such as the Surlyn® 8625 and Surlyn® 8629 combinations disclosed in U.S. Pat. No. 4,884,814).

In addition, lotek® 7510, when compared to lotek® 7520, produces slightly higher C.O.R. values at equal softness/hardness due to the lotek® 7510's higher hardness and neutralization. Similarly, lotek® 7510 produces better release properties (from the mold cavities) due to its slightly higher stiffness and lower flow rate than lotek® 7520. This is important in production where the soft covered balls tend to have lower yields caused by sticking in the molds and subsequent punched pin marks from the knockouts. According to Exxon, lotek® 7510 is of similar chemical composition as lotek® 7520 (i.e. a zinc salt of a terpolymer of ethylene, acrylic acid, and methyl acrylate) but is more highly neutralized. Based upon FTIR analysis, lotek® 7520 is estimated to be about 30-40 wt.-% neutralized and lotek® 7510 is estimated to be about 40-60 wt.-% neutralized. The typical properties of lotek® 7510 in comparison of those of lotek® 7520 in comparison of those of lotek® 7520 are set forth below in Table 9:

TABLE 9
Physical Properties of Iotek ® 7510
in Comparison to Iotek ® 7520

| | IOTEK ® 7520 | IOTEK ® 7510 |
|---|---|---|
| MI, g/10 min | 2.0 | 0.8 |
| Density, g/cc | 0.96 | 0.97 |
| Melting Point, ° F. | 151 | 149 |
| Vicat Softening Point, ° F. | 108 | 109 |
| Flex Modulus, psi | 3800 | 5300 |
| Tensile Strength, psi | 1450 | 1750 |
| Elongation, % | 760 | 690 |
| Hardness, Shore D | 32 | 35 |

The hard ionomer resins utilized to produce the outer cover layer composition hard/soft blends include ionic copolymers which are the sodium, zinc, magnesium, lithium, etc. salts of the reaction product of an olefin having from 2 to 8 carbon atoms and an unsaturated monocarboxylic acid having from 3 to 8 carbon atoms. The carboxylic acid groups of the copolymer may be totally or partially (i.e. approximately 15-75 percent) neutralized.

The hard ionomeric resins are likely copolymers of ethylene and acrylic and/or methacrylic acid, with copolymers of ethylene and acrylic acid being the most preferred. Two or more types of hard ionomeric resins may be blended into the outer cover layer compositions in order to produce the desired properties of the resulting golf balls.

As discussed earlier herein, the hard ionomeric resins introduced under the designation Escor® and sold under the designation lotek® are somewhat similar to the hard ionomeric resins sold under the Surlyn® trademark. However, since the lotek® ionomeric resins are sodium or zinc salts of poly(ethylene-acrylic acid) and the Surlyn® resins are zinc or sodium salts of poly(ethylene-methacrylic acid) some distinct differences in properties exist.

As more specifically indicated in the data set forth below, the hard lotek® resins (i.e., the acrylic acid based hard ionomer resins) are the more preferred hard resins for use in formulating the outer layer blends for use in the present invention. In addition, various blends of lotek® and Surlyn® hard ionomeric resins, as well as other available ionomeric resins, may be utilized in the present invention in a similar manner.

Examples of commercially available hard ionomeric resins which may be used in the present invention in formulating the outer cover blends include the hard sodium ionic copolymer sold under the trademark Surlyn® 8940 and the hard zinc ionic copolymer sold under the trademark Surlyn® 9910. Surlyn® 8940 is a copolymer of ethylene with methacrylic acid and about 15 weight percent acid which is about 29 percent neutralized with sodium ions. This resin has an average melt flow index of about 2.8 g/10 min Surlyn® 9910 is a copolymer of ethylene and methacrylic acid with about 15 weight percent acid which is about 58 percent neutralized with zinc ions. The average melt flow index of Surlyn® 9910 is about 0.7 g/10 min. The typical properties of Surlyn® 9910 and 8940 are set forth below in Table 10:

TABLE 10
Typical Properties of Commercially Available Hard Surlyn ® Resins
Suitable for Use in the Outer Layer Blends of the Present Invention

| | ASTM D | 8940 | 9910 | 8920 | 8528 | 9970 | 9730 |
|---|---|---|---|---|---|---|---|
| Cation Type | | Sodium | Zinc | Sodium | Sodium | Zinc | Zinc |
| Melt flow index, | D-1238 | 2.8 | 0.7 | 0.9 | 1.3 | 14.0 | 1.6 |
| gms/10 min. | | | | | | | |
| Specific Gravity, | D-792 | 0.95 | 0.97 | 0.95 | 0.94 | 0.95 | 0.95 |
| g/cm³ | | | | | | | |
| Hardness, Shore D | D-2240 | 66 | 64 | 66 | 60 | 62 | 63 |
| Tensile Strength, | D-638 | (4.8) | (3.6) | (5.4) | (4.2) | (3.2) | (4.1) |
| (kpsi), MPa | | 33.1 | 24.8 | 37.2 | 29.0 | 22.0 | 28.0 |
| Elongation, % | D-638 | 470 | 290 | 350 | 450 | 460 | 460 |
| Flexural Modulus, | D-790 | (51) | (48) | (55) | (32) | (28) | (30) |
| (kpsi) MPa | | 350 | 330 | 380 | 220 | 190 | 210 |
| Tensile Impact (23° C.) | D-1822S | 1020 | 1020 | 865 | 1160 | 760 | 1240 |
| KJ/m₂ (ft.-lbs./in²) | | (485) | (485) | (410) | (550) | (360) | (590) |
| Vicat Temperature, ° C. | D-1525 | 63 | 62 | 58 | 73 | 61 | 73 |

Examples of the more pertinent acrylic acid based hard ionomer resin suitable for use in the present outer cover composition sold under the lotek® trade name by the Exxon Corporation include lotek® 8000, 8010, 8020, 8030, 7030, 7010, 7020, 1002, 1003, 959 and 960. The physical properties of lotek® 959 and 960 are shown above. The typical properties of the remainder of these and other lotek® hard ionomers suited for use in formulating the outer layer cover composition are set forth below in Table 11:

TABLE 11
Typical Properties of Iotek ® Ionomers

| | | ASTM | | | | | | |
|---|---|---|---|---|---|---|---|---|
| | | Method | Units | 4000 | 4010 | 8000 | 8020 | 8030 |
| Resin | | | | | | | | |
| Properties | | | | | | | | |
| Cation type | | | | zinc | zinc | sodium | sodium | sodium |
| Melt index | | D-1238 | g/10 min. | 2.5 | 1.5 | 0.8 | 1.6 | 2.8 |
| Density | | D-1505 | kg/m³ | 963 | 963 | 954 | 960 | 960 |
| Melting Point | | D-3417 | ° C. | 90 | 90 | 90 | 87.5 | 87.5 |
| Crystallization | | D-3417 | ° C. | 62 | 64 | 56 | 53 | 55 |
| Point | | | | | | | | |
| Vicat Softening | | D-1525 | ° C. | 62 | 63 | 61 | 54 | 67 |
| Point | | | | | | | | |
| % Weight Acrylic Acid | | | | 16 | | 11 | | |
| % of Acid Groups | | | | 30 | | 40 | | |
| cation neutralized | | | | | | | | |
| Plaque | | | | | | | | |
| Properties | | | | | | | | |
| (3 mm thick, | | | | | | | | |
| compression molded) | | | | | | | | |
| Tensile at break | | D-638 | Mpa | 24 | 26 | 36 | 31.5 | 28 |
| Yield point | | D-638 | MPa | none | none | 21 | 21 | 23 |
| Elongation at break | | D-638 | % | 395 | 420 | 350 | 410 | 395 |
| 1% Secant modulus | | D-638 | MPa | 160 | 160 | 300 | 350 | 390 |
| Shore Hardness D | | D-2240 | — | 55 | 55 | 61 | 58 | 59 |
| Film Properties | | | | | | | | |
| (50 micron film 2.2:1 | | | | | | | | |
| Blow-up ratio) | | | | | | | | |
| Tensile at Break | MD | D-882 | MPa | 41 | 39 | 42 | 52 | 47.4 |
| | TD | D-882 | MPa | 37 | 38 | 38 | 38 | 40.5 |
| Yield point | MD | D-882 | MPa | 15 | 17 | 17 | 23 | 21.6 |
| | TD | D-882 | MPa | 14 | 15 | 15 | 21 | 20.7 |
| Elongation at Break | MD | D-882 | % | 310 | 270 | 260 | 296 | 305 |
| | TD | D-882 | % | 360 | 340 | 280 | 340 | 345 |
| 1% Secant modulus | MD | D-882 | MPa | 210 | 215 | 390 | 380 | 380 |
| | TD | D-882 | MPa | 200 | 225 | 380 | 350 | 345 |

| | | | | | |
|---|---|---|---|---|---|
| Dart Drop Impact | D-1709 | g/micron | 12.4 | 12.5 | 20.3 |

| | ASTM | | | | |
|---|---|---|---|---|---|
| | Method | Units | 7010 | 7020 | 7030 |
| Resin Properties | | | | | |
| Cation type | | | zinc | zinc | zinc |
| Melt Index | D-1238 | g/10 min. | 0.8 | 1.5 | 2.5 |
| Density | D-1505 | kg/m³ | 960 | 960 | 960 |
| Melting Point | D-3417 | ° C. | 90 | 90 | 90 |
| Vicat Softening Point | D-1525 | ° C. | 60 | 63 | 62.5 |
| Plaque Properties | | | | | |
| (3 mm thick, compression | | | | | |
| molded) | | | | | |
| Tensile at break | D-638 | MPa | 38 | 38 | 38 |
| Yield Point | D-638 | MPa | none | none | none |
| Elongation at break | D-638 | % | 500 | 420 | 395 |
| Shore Hardness D | D-2240 | — | 57 | 55 | 55 |

It has been determined that when hard/soft ionomer blends are used for the outer cover layer, good results are achieved when the relative combination is in a range of about 3-25 percent hard ionomer and about 75-97 percent soft ionomer.

Polyurethane Materials

As previously noted, either or both of the inner and outer cover layers may comprise one or more polyurethane materials. It is preferred that the outer cover layer comprise a polyurethane material. Before describing the various polyurethanes preferred for use in the present invention golf balls, it is instructive to review the chemistry and nature of polyurethanes.

Polyurethanes are polymers which are used to form a broad range of products. They are generally formed by mixing two primary ingredients during processing. For the most commonly used polyurethanes, the two primary ingredients are a polyisocyanate (for example, diphenylmethane diisocyanate monomer (“MDI”) and toluene diisocyanate (“TDI”) and their derivatives) and a polyol (for example, a polyester polyol or a polyether polyol).

A wide range of combinations of polyisocyanates and polyols, as well as other ingredients, are available. Furthermore, the end use properties of polyurethanes can be controlled by the type of polyurethane utilized, i.e., whether the material is thermoset (cross linked molecular structure) or thermoplastic (linear molecular structure).

Cross linking occurs between the isocyanate groups (—NCO) and the polyol's hydroxyl end-groups (—OH). Additionally, the end use characteristics of polyurethanes can also be controlled by different types of reactive chemicals and processing parameters. For example, catalysts are utilized to control polymerization rates. Depending upon the processing method, reaction rates can be very quick (as in the case for some reaction injection molding systems (i.e., “RIM”)) or may be on the order of several hours or longer (as in several coating systems). Consequently, a great variety of polyurethanes are suitable for different end uses.

Polyurethanes are typically classified as thermosetting or thermoplastic. A polyurethane becomes irreversibly “set” when a polyurethane prepolymer is cross linked with a polyfunctional curing agent, such as a polyamine or a polyol. The prepolymer typically is made from polyether or polyester. Diisocyanate polyethers are preferred because of their water resistance.

The physical properties of thermoset polyurethanes are controlled substantially by the degree of cross linking. Tightly cross linked polyurethanes are fairly rigid and strong. A lower amount of cross linking results in materials that are flexible and resilient. Thermoplastic polyurethanes have some cross linking, but primarily by physical means. The crosslinking bonds can be reversibly broken by increasing temperature, as occurs during molding or extrusion. In this regard, thermoplastic polyurethanes can be injection molded, and extruded as sheet and blow film. They can be used up to about 350° F. and are available in a wide range of hardnesses.

Polyurethanes typically are formed by reacting a polyol with a polyisocyanate. In some cases, the polyisocyanate is in the form of a polyurethane prepolymer formed from a polyether or polyester and a polyisocyanate. The polyol or polyamine is typically referred to as a “curing” agent. Examples of reactants used to form polyurethanes by this technique are discussed in U.S. Pat. No. 5,006,297, herein incorporated by reference. In other cases a polyester or acrylic polyol is reacted with a polyisocyanate.

Two types of polyisocyanates are predominantly used to make polyurethanes, diphenylmethane diisocyanate monomer (MDI) and its derivatives, and toluene diisocyanate (TDI) and its derivatives.

MDI is the most widely used polyisocyanate. Both rigid and flexible foams, reaction injection moldings, elastomers, coatings, and casting compounds are made from MDI. There are three basic grades of MDI, polymeric MDI, pure MDI, and pure MDI derivatives.

Polymeric MDI is used in both cellular and non-cellular products. However, because of the high thermal insulation properties possible with polymeric MDI, its main use is in closed-cell, rigid foam insulation for the construction and refrigeration industries. Other uses are high-resilience (HR) flexible foam, carpet backing, and binders.

Pure MDI, which is produced from polymeric MDI, is a low-melting-temperature (about 100° F.) solid. Its primary use is in thermoplastic and cast elastomers. It also is used as an additive for synthetic fibers to achieve high fiber tenacity and elongation.

Pure MDI derivatives are tailored to provide specific processing and reaction characteristics. A major use for these solvent-free liquids is in reaction injection molding (RIM), but they also find application in integral skin moldings, semi-flexible moldings, and cast elastomers.

Toluene diisocyanate, TDI, is used almost exclusively to make flexible foam. TDI, however, also finds some use in elastomers, sealants, and coatings. TDI's generally are water-white liquids which have much higher isocyanate (—NCO) contents than any MDI, but lower molecular weights.

MDI and TDI also are blended, particularly for producing flexible molded foams. The free-flowing, brown liquid blends have nearly as high isocyanate contents as TDI.

A wide array of isocyanes may be used in forming polyurethanes for use in the present invention, such as p-phenylene diisocyanate (PPDI) (CAS Registry No. 104494); toluene diisocyanate (TDI) (CAS Registry No. 1321-38-6); 4,4′-methylenebis-(phenylisocyanate) (MDI) (CAS Registry No. 101-68-8); polymethylene polyphenyl isocyanate (PMDI) (CAS Registry No. 9016-87-9);

1,5-naphthalene diisocyanate (NDI) (CAS Registry No. 3173-72-6); bitolylene diisocyanate (TODI) (CAS Registry No. 91-974); m-xylylene diisocyanate (XDI) (CAS Registry No. 3634-83-1); m-tetramethyl-xylylene (TMXDI) (CAS Registry No. 5806742-8); hexamethylene diisocyanate (HDI) (CAS Registry No. 822-06-0); 1,6-diisocyanato-2,2,4,4-tetra-methylhexane (TMDI) (CAS Registry No. 83748-30-5); 1,6-diisocyanato-2,4,4-trimethylhexane (TMDI) (CAS Registry No. 5646-96-5); trans-cyclohexane-1,4-diisocyanate (CHDI) (CAS Registry No. 2556-36-7); 1,3-bis(isocyanato-methyl)cyclohexane (HXDI) (CAS Registry No. 38661-72-2); 3-isocyanato-methyl-3,5,5-trimethylcyclo-hexyl isocyanate (IPDI) (CAS Registry No. 4098-71-9); dicyclohexylmethane diisocyanate (HMDI) (CAS Registry No. 5124-30-1).

Two basic types of polyols are used in polyurethanes systems:

polyesters and polyethers. Polyethers are the most widely used.

Often in referring to polyols, their functionality is specified. The functionality pertains to the number of reactive sites, which in turn, controls crosslinking. The more crosslinked (higher functionality), the more rigid will be the polyurethane. Functionality is controlled by the initiator used to manufacture the polyol. Glycerine, for example, is commonly used to initiate triol (3 functional) polyols. To this initiator is added an oxide such as propylene oxide, ethylene oxide, or a combination, to extend the molecular chain and tailor final processing and performance characteristics of the polyol. Triols typically are used to produce flexible foams; diols are used for elastomers, coatings, and sealants; and tetrols typically are used for rigid foams.

Polyether-based polyols have greater resistance to hydrolysis. Polyether polyols can be modified by the in-situ polymerization of acrylonitrile/styrene monomers. The resulting graft polyols generally produce flexible foams with improved load-bearing properties as well as greater tensile and tear strengths. Depending on the backbone on which these vinyl monomers are grafted, a wide range of performance characteristics can be developed.

Polyester polyols yield polyurethanes with greater strength properties, wear resistance, and thermal stability than polyether polyurethanes, and they can absorb more energy. These materials, however, are generally more expensive than polyethers.

Polyester polyols are typically classed by molecular weight. Low molecular weight polyols (less than 1500) are used in coatings, casting compounds, and rigid foams. Medium molecular weight polyols (1550 to 2500) are used in elastomers. And, high molecular weight polyols (greater than 2500) are used in flexible foams.

Thermoset polyurethanes are typically crosslinked and cannot be repeatedly thermoformed. On the other hand, thermoplastic polyurethanes are similar to other thermoplastics in that they can be repeatedly plasticized by the influence of temperature and pressure.

A preferred crosslinkable thermoplastic polyurethane used to form a game ball according to the present invention is initially a thermoplastic, and in this state can be melted and solidified repeatedly. However, the material can be readily crosslinked, thereby increasing its hardness and providing that it cannot be reversibly melted without thermal degradation.

A wide array of crosslinkable thermoplastic polyurethanes can be used in the present invention. For example, EBXL-TPU is a thermoplastic polyurethane recently made available from Zylon Polymers, 23 Mountain Avenue, Monsey, N.Y. 10952. EBXL-TPU is a pelletized, medical grade, polyether or polyester based thermoplastic polyurethane, reactor modified to allow crosslinking by ionizing radiation. It is a low melt index material suitable for extrusion into profiles, film and sheet, or injection molding. Once crosslinked, the material combines the ease of processing and toughness of TPU with the improved resistance to water, solvents and elevated temperatures characteristic of thermoset materials. Table 12 below, sets forth details of this preferred material.

TABLE 12
EBXL-TPU
Typical Physical Properties

| PROPERTY | VALUE | UNITS |
|---|---|---|
| Radiation | 12.5-15 | MegaRads |
| Shore Hardness | 80 | Shore A |
| Specific Gravity | 1.04 | gr/cc |
| Tensile Strength | 5000 | psi |
| Ultimate Elongation | 425 | % |
| Compression set, | 50 | % |
| 70 hrs @ 100 deg C. | | |
| Melt Flow Index | 2 | gms/10 min |
| FLUID RESISTANCES | | |
| Water, | no effect | |
| 24 hrs @ 23 C. | | |
| Isopropyl Alcohol, | no effect | |
| 100% 24 hrs @ 23 C. | | |
| Tetrahydrofuran, | swells, does not dissolve | |
| 24 hrs @ 23 C. | | |

A further preferred class of crosslinkable thermoplastic polyurethanes is a commercially available polyurethane from BASF, designated as Elastollan®. Properties of several specific formulations of Elastollan ® polyurethanes are set forth in Table 13 below.

TABLE 13

| | | ASTM | | | | | | | | | |
|---|---|---|---|---|---|---|---|---|---|---|---|
| Physical properties¹ | Units | Method | 1175AW³ | 1180A | 1185A | 1190A | 1195A | 1154D | 1160D | 1164D | 1174D |
| Specific gravity | gr/cc | D-792 | 1.14 | 1.11 | 1.12 | 1.13 | 1.14 | 1.16 | 1.17 | 1.18 | 1.19 |
| Hardness | Shore A | D-224 | 76 ± 2 | 80 ± 2 | 86 ± 2 | 91 ± 2 | 95 ± 2 | — | — | — | — |
| | D | | — | — | — | 42 ± 2 | 47 ± 2 | 53 ± 2 | 60 ± 2 | 64 ± 2 | 73 ± 2 |
| Tensile strength | MPa | D-412 | 30 | 32 | 33 | 37 | 36 | 40 | 40 | 41 | 45 |
| | psi | | 4500 | 4700 | 4800 | 5300 | 5200 | 5800 | 5800 | 6000 | 6500 |
| Tensile stress | | | | | | | | | | | |
| @ 100% elongation | MPa | D-412 | 4.3 | 5.5 | 7.6 | 10 | 12 | 20 | 22 | 25 | 32 |
| | psi | | 620 | 800 | 1100 | 1500 | 1750 | 2900 | 3200 | 3600 | 4600 |
| @ 300% elongation | MPa | | 8.3 | 10 | 12 | 17 | 21 | 30 | 33 | 33 | 38 |
| | psi | | 1180 | 1500 | 1750 | 2500 | 3000 | 4300 | 4800 | 4800 | 5500 |
| Elongation @ brk. | % | D-412 | 740 | 600 | 640 | 575 | 490 | 460 | 415 | 425 | 350 |
| Tensile set @ brk. | % | D-412 | — | 45 | 70 | 75 | 65 | 70 | 60 | 90 | 80 |
| Tear strength | kN/m | D-624 | 80 | 90 | 105 | 125 | 140 | 180 | 205 | 220 | 255 |
| | pli | DIE C | 460 | 515 | 600 | 715 | 800 | 1025 | 1170 | 1250 | 1450 |
| Abrasion resistance | mg | D-1044² | | 25 | 30 | 45 | 55 | 75 | 50 | 55 | 75 |
| | (loss) | (Taber) | | | | | | | | | |

NOTE:
¹Test samples were cured 20 hours @ 100° C. before testing.
²H-18 wheel, 1000 gm weight and 1000 cycles.
³Contains proprietary plasticizer.

Elastollan® 1100 series of products are polyether-based thermoplastic polyurethanes. They exhibit excellent low temperature properties, hydrolysis resistance and fungus resistance. These products can be injection and blow molded and extruded.

BASF indicates that Elastollan® 11 75AW, 80A, 90A and 95A are suitable for extrusion. And, Elastollan® 1175AW to 1174D are suitable for injection molding. BASF further provides that a grade should be dried before processing. Elastollan® can be stored for up to 1 year in its original sealed container. Containers should be stored in a cool, dry area. Elastollan® TPU's from BASF are commercial TPU's but will not crosslink using irradiation unless a particular reactive co-agent such as Liquiflex™ H, described below, is added. Nearly any other commercially available TPU such as Urepan®, Pellethane®, Morthane®, Desmopan®, etc. can be used provided it is compounded with a co-agent that readily crosslinks with radiation.

Liquiflex™ is a commercially available hydroxyl terminated polybutadiene (HTPB), from Petroflex. It is believed that this co-agent enables the thermoplastic polyurethane to crosslink upon exposure to radiation. It is believed that the previously noted thermoplastic polyurethane EBXL-TPU from Zylon Polymers contains a co-agent similar to Liquiflex™.

As indicated above, numerous ways are known to induce crosslinking in a polymer by free radical initiation, including peroxide initiation and irradiation. The golf ball covers of the present invention preferably are crosslinked by irradiation, and more preferably by light rays such as gamma or UV irradiation. Furthermore, other forms of particle irradiation, including electron beam also can be used. Gamma radiation is preferred as golf balls or game balls can be irradiated in bulk. Gamma penetrates very deep but also increases crosslinking of the inner core and the compression of the core has to be adjusted to allow for the increase in hardness.

Electron beam techniques are faster but cannot be used for treating in bulk as the electron beam does not penetrate very deep and the product needs to be rotated to obtain an even crosslink density.

The type of irradiation to be used will depend in part upon the underlying layers. For example, certain types of irradiation may degrade windings in a wound golf ball. On the other hand, balls with a solid core would not be subject to the same concerns. However, with any type of core, certain types of irradiation will tend to crosslink and thus harden the core. Depending upon whether this type of effect is sought or is to be avoided, the appropriate type of irradiation can be selected.

The level of radiation employed depends upon the desired end characteristics of the final game ball, e.g. golf ball, cover. However, generally a wide range of dosage levels may be used. For example, total dosages of up to about 12.5, or even 15 Mrads may be employed. Preferably, radiation delivery levels are controlled so that the game ball is not heated above about 80° C. (176° F.) while being crosslinked.

The thermoplastic polyurethane of the present invention is superior to conventional thermoset polyurethanes in processing in that it can be melted and reformed, and because its hardness can be readily controlled using a variety of radiation dosages. The hardness can be controlled by one or more of the following techniques. Hardness may be controlled by selecting the base TPU polymer having the desired hardness. Alternatively, or in addition, the amount of reactive co-agent (Liquiflex™ H or similar co-agent) may be increased or decreased. Alternatively, or in addition, hardness may be controlled by increasing or decreasing the level of radiation. Alternatively or in addition, fillers such as silica may be added to increase the hardness. The previously noted formulation from Zylon Polymers is proprietary but it probably contains a co-agent that crosslinks with radiation.

The crosslinkable thermoplastic polyurethane cover of the invention is superior to a balata cover in that crosslinked thermoplastic polyurethanes exhibit superior cut and scuff resistance.

Additional non-limiting examples of suitable polyurethane systems for use in the present invention are Bayflex® elastomeric polyurethane systems, Baydur® GS solid polyurethane systems, Prism® solid polyurethane systems, all from Bayer Corp. (Pittsburgh, Pa.), Spectrim® reaction moldable polyurethane and polyurea systems from Dow Chemical USA (Midland, Mich.), including Spectrim® MM 373-A (isocyanate) and 373-B (polyol), and Elastolit® SR systems from BASF (Parsippany, N.J.). Preferred systems include Bayflex® MP-10000 and Bayflex® 110-50, filled and unfilled. Further preferred examples are polyols, polyamines and isocyanates formed by processes for recycling polyurethanes and polyureas.

Moreover, in alternative embodiments, the outer cover layer formulation may also comprise up to 100 wt % of a soft, low modulus non-ionomeric thermoplastic material including a polyester polyurethane such as B.F. Goodrich Company's Estane® polyester polyurethane X-4517. The non-ionomeric thermoplastic material may be blended with a soft ionomer. For example, polyamides blend well with soft ionomer. According to B.F. Goodrich, Estane® X-4517 has the following properties:

TABLE 14
Properties of Estane ® X-4517

| | |
|---|---|
| Tensile | 1430 |
| 100% | 815 |
| 200% | 1024 |
| 300% | 1193 |
| Elongation | 641 |
| Youngs Modulus | 1826 |
| Hardness A/D | 88/39 |
| Bayshore Rebound | 59 |
| Solubility in Water | Insoluble |
| Melt processing temperature | >350° F. (>177° C.) |
| Specific Gravity (H₂O = 1) | 1.1-1.3 |

Other soft, relatively low modulus non-ionomeric thermoplastic elastomers may also be utilized to produce the outer cover layer as long as the non-ionomeric thermoplastic elastomers produce the playability and durability characteristics desired without adversely effecting the enhanced travel distance characteristic produced by the high acid ionomer resin composition. These include, but are not limited to thermoplastic polyurethanes such as Texin® thermoplastic polyurethanes from Mobay Chemical Co. and the Pellethane® thermoplastic polyurethanes from Dow Chemical Co.; non-ionomeric thermoset polyurethanes including but not limited to those disclosed in U.S. Pat. No. 5,334,673, herein incorporated by reference; cross-linked metallocene catalyzed polyolefins; ionomer/rubber blends such as those in Spalding U.S. Pat. Nos. 4,986,545; 5,098,105 and 5,187,013, all of which are hereby incorporated by reference; and, Hytrel® polyester elastomers from DuPont and Pebax® polyetheramides from Elf Atochem S.A.

Dual Core

As noted, the present invention golf balls utilize a unique dual core configuration. Preferably, the cores comprise (i) an interior spherical center component formed from a thermoset material, a thermoplastic material, or combinations thereof and (ii) a core layer disposed about the spherical center component, the core layer formed from a thermoset material, a thermoplastic material, or combinations thereof. Most preferably, the core layer is disposed immediately adjacent to, and in intimate contact with the center component. The cores may further comprise (iii) an optional outer core layer disposed about the core layer. Most preferably, the outer core layer is disposed immediately adjacent to, and in intimate contact with the core layer. The outer core layer may be formed from a thermoset material, a thermoplastic material, or combinations thereof.

Preferably, the core center component comprises one or more density-increasing filler materials that are combined with one or more polymeric materials. For example, a preferred combination of materials includes one or more density-increasing filler materials dispersed throughout a polybutadiene material. Examples of preferred density-increasing materials are included herein. It is contemplated that one or more density-reducing fillers may be utilized in the present invention golf balls.

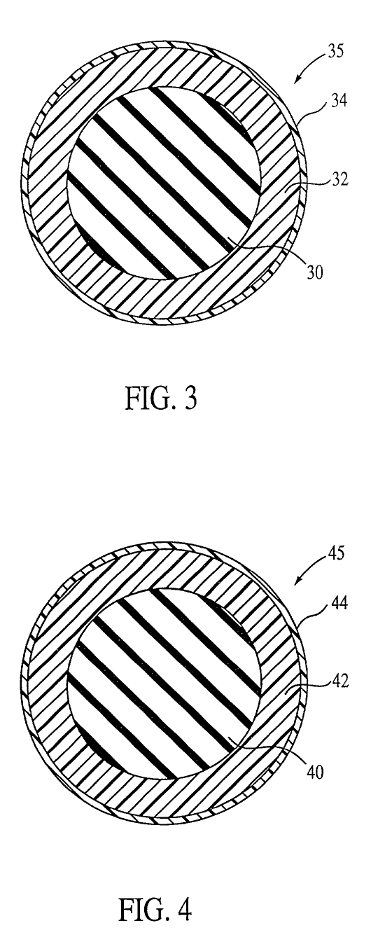

The present invention provides several additionally preferred embodiment golf balls utilizing the unique dual core configuration and the previously described cover layers. Referring to FIG. 3, a preferred embodiment golf ball 35 is illustrated comprising a core center component 30 formed from a thermoset material surrounded by a core layer 32 formed from a thermoplastic material. The core center component 30 further comprises one or more density-increasing materials described in greater detail herein. A single or multi-layer cover 34 surrounds the core center component 30 and core layer 32. The cover 34 preferably corresponds to the previously described multi-layer cover 12.

As illustrated in FIG. 4, another preferred embodiment golf ball 45 in accordance with the present invention is illustrated. The preferred embodiment golf ball 45 comprises a core center component 40 formed from a thermoplastic material surrounded by a core layer 42. The core layer 42 is formed from a thermoset material. The core center component 40 further comprises one or more density-increasing materials described in greater detail herein. A single or multi-layer cover 44 surrounds the core center component 40 and the core layer 42. Again, the cover 44 preferably corresponds to the previously described multi-layer cover 12.

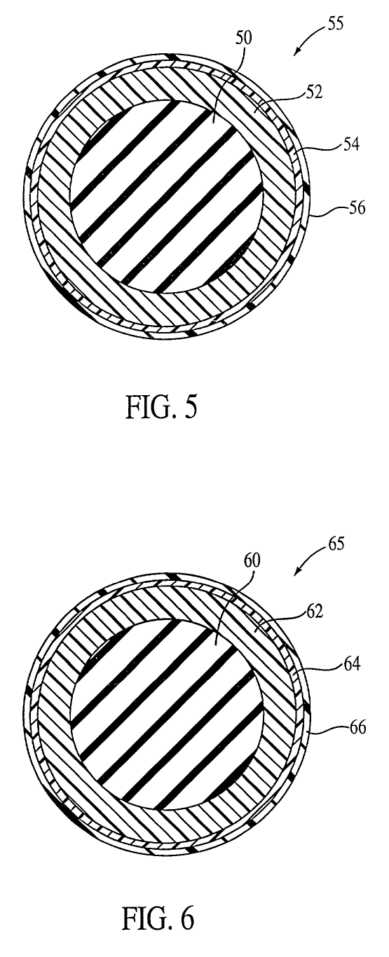

FIG. 5 illustrates yet another preferred embodiment golf ball 55 in accordance with the present invention. The preferred embodiment golf ball 55 comprises a core center component 50 formed from a thermoplastic material. A core layer 52 surrounds the core center component 50. The core layer 52 is formed from a thermoplastic material which may be the same as the material utilized with the core 50, or one or more other or different thermoplastic materials. The preferred embodiment golf ball 55 utilizes an optional outer core layer 54 that surrounds the core component 50 and the core layer 52. The outer core layer 54 is formed from a thermoplastic material which may be the same or different than any of the thermoplastic materials utilized by the core center component 50 and the core layer 52. The golf ball 55 further comprises a single or multi-layer cover 56 that is preferably similar to the previously described multi-layer cover 12.

FIG. 6 illustrates yet another preferred embodiment golf ball 65 in accordance with the present invention. The preferred embodiment golf ball 65 comprises a core center component 60 formed from a thermoplastic, thermoset material, or any combination of a thermoset and thermoplastic material. A core layer 62 surrounds a core center component 60. The core layer 62 is formed from a thermoset material. The preferred embodiment golf ball 65 also comprises an optional outer core layer 64 formed from a thermoplastic material. A single or multi-layer cover 66, preferably similar to the previously described multi-layer cover 12, is disposed about, and generally surrounds, the core center 60, the core layer 62 and the outer core 64.

A wide array of thermoset materials can be utilized in the present invention dual cores. Examples of suitable thermoset materials include butadiene or any natural or synthetic elastomer, including metallocene polyolefins, polyurethanes, silicones, polyamides, polyureas, or virtually any irreversibly cross-linked resin system. It is also contemplated that epoxy, phenolic, and an array of unsaturated polyester resins could be utilized.

The thermoplastic materials utilized in the present invention golf balls and, particularly their dual cores, may be nearly any thermoplastic material. Examples of typical thermoplastic materials for incorporation in the golf balls of the present invention include, but are not limited to, ionomers, polyurethane thermoplastic elastomers, and combinations thereof. It is also contemplated that a wide array of other thermoplastic materials could be utilized, such as polysulfones, fluoropolymers, polyamide-imides, polyarylates, polyaryletherketones, polyaryl sulfones/polyether sulfones, polybenzimidazoles, polyether-imides, polyimides, liquid crystal polymers, polyphenylene sulfides; and specialty high-performance resins, and ultrahigh molecular weight polyethylenes.

Additional examples of suitable thermoplastics include metallocenes, polyvinyl chlorides, acrylonitrile-butadiene-styrenes, acrylics, styrene-acrylonitriles, styrene-maleic anhydrides, polyamides (nylons), polycarbonates, polybutylene terephthalates, polyethylene terephthalates, polyphenylene ethers/polyphenylene oxides, reinforced polypropylenes, and high-impact polystyrenes.

Preferably, the thermoplastic materials have relatively high melting points, such as a melting point of at least about 300° F. Several examples of these preferred thermoplastic materials and which are commercially available include, but are not limited to, Capron® (a blend of nylon and ionomer), Lexan® polycarbonate, Pebax®, and Hytrel®. The polymers or resin system may be cross-linked by a variety of means such as by peroxide agents, sulphur agents, radiation or other cross-linking techniques.

Any or all of the previously described components in the cores of the golf ball of the present invention may be formed in such a manner, or have suitable fillers added, so that their resulting density is decreased or increased. For example, any of these components in the dual cores could be formed or otherwise produced to be light in weight. For instance, the components could be foamed, either separately or in-situ. Related to this, a foamed light weight filler agent may be added. In contrast, any of these components could be mixed with or otherwise receive various high density filler agents or other weighting components such as relatively high density fibers or particulate agents in order to increase their mass or weight. Particularly preferred density-increasing agents are described in greater detail herein.

The following commercially available thermoplastic resins are particularly preferred for use in the noted dual cores employed in the golf balls of the present invention: Capron® 8351 (available from Allied Signal Plastics), Lexan® ML5776 (from General Electric), Pebax® 3533 (a polyether block amide from Elf Atochem), and Hytrel® G4074 (from DuPont). Properties of these four preferred thermoplastics are set forth below in Tables 15-18. When forming a golf ball in accordance with the present invention, if the interior center component of the dual core is to comprise a thermoplastic material, it is most preferred to utilize Pebax® thermoplastic resin.

TABLE 15
CAPRON ® 8351

| | | ASTM Test |
|---|---|---|
| MECHANICAL | | |
| Tensile Strength, Yield, psi (Mpa) | 7,800 (54) | D-638 |
| Flexural Strength, psi (Mpa) | 9,500 (65) | D-790 |
| Flexural Modulus, psi (Mpa) | 230,000 (1,585) | D-790 |
| Ultimate Elongation, % | 200 | D-638 |
| Notched Izod Impact, ft-lbs/in (J/M) | No Break | D-256 |
| Drop Weight Impact, ft-lbs (J) | 150 (200) | D-3029 |
| Drop Weight Impact, @ −40° F., | 150 (200) | D-3029 |
| ft-lbs (J) | | |
| PHYSICAL | | |
| Specific Gravity | 1.07 | D-792 |
| THERMAL | | |
| Melting Point, ° F. (° C.) | 420 (215) | D-789 |
| Heat Deflection @ 264 psi ° F. (° C.) | 140 (60) | D-648 |

TABLE 16
Lexan ® ML5776

| PROPERTY | TYPICAL DATA | UNIT | METHOD |
|---|---|---|---|
| MECHANICAL | | | |
| Tensile Strength, yield, | 8500 | psi | ASTM D 638 |
| Type I, 0.125″ | | | |
| Tensile Strength, break, | 9500 | psi | ASTM D 638 |
| Type I, 0.125″ | | | |
| Tensile Elongation, | 110.0 | % | ASTM D 638 |
| yield, Type I, 0.125″ | | | |
| Flexural Strength, | 12000 | psi | ASTM D 790 |
| yield, 0.125″ | | | |
| Flexural Modulus, | 310000 | psi | ASTM D 790 |
| 0.125″ | | | |
| IMPACT | | | |
| Izod Impact, | 60.0 | ft-lb/in | ASTM D 4812 |
| unnotched, 73 F. | | | |
| Izod Impact, | 15.5 | ft-lb/in | ASTM D 256 |
| notched, 73 F. | | | |
| Izod Impact, | 12.0 | ft-lb/in | ASTM D 256 |
| notches 73 F., 0.250″ | | | |
| Instrumented Impact | 48.0 | ft-lbs | ASTM D 3763 |
| Energy @ Peak, 73 F. | | | |
| THERMAL | | | |
| HDT, 264 psi, | 257 | deg F. | ASTM D 648 |
| 0.250″, unannealed | | | |
| Thermal Index, | 80 | deg C | UL 7468 |
| Elec Prop | | | |
| Thermal Index, | 80 | deg C | UL 7468 |
| Mech Prop with Impact | | | |
| Thermal Index, Mech | 80 | deg C | UL 7468 |
| Prop without Impact | | | |
| PHYSICAL | | | |
| Specific Gravity, solid | 1.19 | — | ASTM D 792 |
| Water Absorption, | 0.150 | % | ASTM D 570 |
| 24 hours @ 73 F. | | | |
| Mold Shrinkage, flow, | 5.7 | in/in E-3 | ASTM D 955 |
| 0.125″ | | | |
| Melt Flow Rate, nom'l, | 7.5 | g/10 min | ASTM D 1238 |
| 300 C/1.2 kgf(0) | | | |
| FLAME | | | |
| CHARACTERISTICS | | | |
| UL File Number, USA | E121562 | — | — |
| 94HB Rated | 0.060 | inch | UL94 |
| (tested thickness) | | | |

TABLE 17
PEBAX ® RESINS

| | ASTM | | |
|---|---|---|---|
| | TEST | | |
| PROPERTY | METHOD | UNITS | 3533 |
| Specific Gravity | D792 | sp 23/23C | 0.5 |
| Water Absorption | D570 | 1.2 | |
| Equilibrium | | | |
| (20° C., 50% R.H.>) | | | |
| 24 Hr. Immersion | | | |
| Hardness | D2240 | | 35D |
| Tensile Strength, Ultimate | D638 | psi | 5600 |
| Elongation, Ultimate | D638 | | 580 |
| Flexural Modulus | D790 | psi | 2800 |
| Izod Impact, Notched | D256 | ft- | |
| 20° C. | | lb./in. | NB |
| −40° C. | | | NB |
| Abrasion Resistance | D1044 | Mg/1000 | 104 |
| H18/1000 g | | Cycles | |
| Tear Resistance Notched | D6240 | lb/in. | 260 |
| Melting Point | D3418 | ° F. | 306 |
| Vicat Softening Point | D1525 | ° F. | 165 |
| HDT 66 psi | D648 | ° F. | 115 |
| Compression Set | | | |
| (24 hr., 160 ° F.) | D395A | % | 54 |

TABLE 18
HYTREL ® G4074
Thermoplastic Elastomer

| | ASTM TEST | | |
|---|---|---|---|
| PHYSICAL | METHOD | UNITS | VALUE |
| Dens/Sp Gr | ASTM D792 | sp gr 23/23 C. | 1.1800 |
| Melt Flow | ASTM D1238 | g/10 min | 5.20 @ E − |
| | | | 190 C./2.16 kg |
| Wat Abs | ASTM D570 | | 2.100% |
| MECHANICAL | | | |
| Elong @ Brk | ASTM D638 | 230.0% | |
| Flex Mod | ASTM D790 | 9500 psi | |
| TnStr @ Brk | ASTM D638 | 2000 psi | |
| IMPACT | | | |
| Notch Izod | ASTM D256 | No Break @ 73.0 F. @ 0.2500 | |
| | | inft-Ib/in | |
| | | 0.50 @ −40.0 F. @ 0.2500 | |
| | | inft-Ib/in | |
| HARDNESS | | | |
| Shore D | ASTM D2240 | | 40 |
| THERMAL | | | |
| DTUL @ 66 | ASTM 0648 | | 122 F. |
| Melt Point | | | 338.0 F. |
| Vicat Soft | ASTM D1525 | | 248 F. |
| Melt Point | | | |

As will be appreciated, the present invention golf balls also encompass dual core assemblies in which either or both of the center component and/or the core layer comprises a polybutadiene material.

In a particularly preferred embodiment, the present invention golf ball utilizes a core center component that comprises (i) at least one of a thermoset material and a thermoplastic material in combination with (ii) a density adjusting material. More preferably, this core center component has a core outer layer disposed about it to thereby form a core assembly. This most preferred golf ball embodiment further comprises a cover layer formed about the previously described core assembly wherein the cover layer includes a polyurethane material. The polyurethane material may be as previously described herein. The cover layer may be a single cover layer or a multi-layer cover assembly. Most preferably, the cover layer is a multi-layer cover assembly having a first inner cover layer and a second outer cover layer.

As previously explained, depending upon the particular application, it may be desirable to utilize an inner cover layer that is at least 5 or more units or “points” harder or softer on the Shore D hardness scale than a corresponding outer cover layer. Thus, for instance, if the Shore D hardness of the outer cover layer is 58, it may be desirable to utilize an inner cover layer having a Shore D hardness of 53 or less; or having a Shore D hardness of 63 or more. Similarly, if the Shore D hardness of the outer cover layer is 62, it may be desirable to provide an inner cover layer having a Shore D hardness of 57 or less; or having a Shore D hardness of 67 or more. Such difference in hardnesses between cover layers is referred to herein as a “hardness differential.” Accordingly, a hardness differential of at least 5, as used herein, refers to a difference in hardness values between two layers under review, of at least 5, as measured on the Shore D scale. The present invention also includes golf balls having hardness differentials of at least 10, 15, 20 and more. The selection of the particular hardness values and their combination will depend upon the desired properties of the resulting golf ball.

A density adjusting filler is used to control the moment of inertia, and thus the initial spin rate of the ball and spin decay. Nonreinforcing fillers are also preferred as they have minimal effect on COR. Preferably, the filler does not chemically react with the resin composition to a substantial degree, although some reaction may occur when, for example, zinc oxide is used in a shell layer which contains some ionomer.

The density-increasing fillers for use in the invention preferably have a specific gravity in the range of from about 1.0 to about 20. The density-reducing fillers for use in the invention preferably have a specific gravity of from about 0.06 to about 1.4, and more preferably from about 0.06 to about 0.90.

Fillers for use in the present invention golf balls may be or are typically in a finely divided form, for example, in a size generally less than about 20 mesh, preferably less than about 100 mesh U.S. standard size, except for fibers and flock, which are generally elongated. Flock and fiber sizes should be small enough to facilitate processing. Filler particle size will depend upon desired effect, cost, ease of addition, and dusting considerations. The filler preferably is selected from the group consisting of precipitated hydrated silica, clay, talc, asbestos, glass fibers, aramid fibers, mica, calcium metasilicate, barium sulfate, zinc sulfide, lithopone, silicates, silicon carbide, diatomaceous earth, polyvinyl chloride, carbonates, metals, metal alloys, tungsten carbide, metal oxides, metal stearates, particulate carbonaceous materials, micro balloons, and combinations thereof. Non-limiting examples of suitable fillers, their densities, and their preferred uses are as follows:

TABLE 19

| Filler Type | Spec. Grav. | Comments |
|---|---|---|
| Precipitated hydrated silica | 2.00 | 1, 2 |
| Clay | 2.62 | 1, 2 |
| Talc | 2.85 | 1, 2 |
| Asbestos | 2.50 | 1, 2 |
| Glass fibers | 255 | 1, 2 |
| Aramid fibers (KEVLAR ® | 1.44 | 1, 2 |
| Mica | 2.80 | 1, 2 |
| Calcium metasilicate | 2.90 | 1, 2 |
| Barium sulfate | 4.60 | 1, 2 |
| Zinc sulfide | 4.10 | 1, 2 |
| Lithopone | 4.2-4.3 | 1, 2 |
| Silicates | 2.10 | 1, 2 |
| Silicon carbide platelets | 3.18 | 1, 2 |
| Silicon carbide whiskers | 3.20 | 1, 2 |
| Tungsten carbide | 15.60 | 1 |
| Diatomaceous earth | 2.30 | 1, 2 |
| Polyvinyl chloride | 1.41 | 1, 2 |
| Carbonates | | |
| Calcium carbonate | 2.71 | 1, 2 |
| Magnesium carbonate | 2.20 | 1, 2 |
| Metals and Alloys (Powders) | | |
| Titanium | 4.51 | 1 |
| Tungsten | 19.35 | 1 |
| Aluminum | 2.70 | 1 |
| Bismuth | 9.78 | 1 |
| Nickel | 8.90 | 1 |
| Molybdenum | 10.20 | 1 |
| Iron | 7.86 | 1 |
| Steel | 7.8-7.9 | 1 |
| Lead | 11.40 | 1, 2 |
| Copper | 8.94 | 1 |
| Brass | 8.2-8.4 | 1 |
| Boron | 2.34 | 1 |
| Boron carbide whiskers | 2.52 | 1, 2 |
| Bronze | 8.70-8.74 | 1 |
| Cobalt | 8.92 | 1 |
| Beryllium | 1.84 | 1 |
| Zinc | 7.14 | 1 |
| Tin | 7.31 | 1 |
| Metal Oxides | | |
| Zinc oxide | 5.57 | 1, 2 |
| Iron oxide | 5.10 | 1, 2 |
| Aluminum oxide | 4.00 | |
| Titanium oxide | 3.9-4.1 | 1, 2 |
| Magnesium oxide | 3.3-3.5 | 1, 2 |
| Zirconium oxide | 5.73 | 1, 2 |
| Metal Stearates | | |
| Zinc stearate | 1.09 | 3, 4 |
| Calcium stearate | 1.03 | 3, 4 |
| Barium stearate | 1.23 | 3, 4 |
| Lithium stearate | 1.01 | 3, 4 |
| Magnesium stearate | 1.03 | 3, 4 |
| Particulate Carbonaceous Materials | | |
| Graphite | 1.5-1.8 | 1, 2 |
| Carbon black | 1.80 | 1, 2 |
| Natural bitumen | 1.2-1.4 | 1, 2 |
| Cotton flock | 1.3-1.4 | 1, 2 |
| Cellulose flock | 1.15-1.5 | 1, 2 |
| Leather fiber | 1.2-1.4 | 1, 2 |
| Micro Balloons | | |
| Glass | 0.15-1.1 | 1, 2 |
| Ceramic | 0.2-0.7 | 1, 2 |
| Flyash | 0.6-0.8 | 1, 2 |
| Coupling Agents and Adhesion | | |
| Promoters | | |
| Titanate | 0.95-1.17 | |
| Zirconates | 0.92-1.11 | |
| Silane | 0.95-1.2 | |

Comments:
1. Particularly useful for adjusting density of the cover layer.
2. Particularly useful for adjusting flex modulus of the cover layer.
3. Particularly useful for adjusting mold release of the cover layer.
4. Particularly useful for increasing melt flow index of the cover layer.

All fillers except for metal stearates would be expected to reduce the melt flow index of an injection molded cover layer.

The amount of filler employed is primarily a function of weight requirements and distribution.

The cores of the inventive golf balls typically have a coefficient of restitution of about 0.750 or more, more preferably 0.770 or more and a PGA compression of about 90 or less, and more preferably 70 or less. The cores have a weight of 25 to 40 grams and preferably 30 to 40 grams. The core can be compression molded. Non-limiting examples of other materials which may be used in the core composition include compatible rubbers or ionomers, and low molecular weight fatty acids such as stearic acid. Free radical initiator catalysts such as peroxides are admixed with the core composition so that on the application of heat and pressure, a curing or cross-linking reaction takes place.

Wound cores are generally produced by winding a very long elastic thread around a solid or liquid filled balloon center. The elastic thread is wound around the center to produce a finished core of about 1.4 to 1.6 inches in diameter, generally. However, the preferred embodiment golf balls of the present invention preferably utilize a solid core, or rather a solid dual core configuration, as opposed to a wound core.

Method of Making Golf Balls

In preparing golf balls in accordance with the present invention, a hard inner cover layer is molded (preferably by injection molding or by compression molding) about a core (preferably a solid core, and most preferably a dual core). A comparatively softer outer layer is molded over the inner layer.

The dual cores of the present invention are preferably formed by compression molding techniques. However, it is fully contemplated that liquid injection molding or transfer molding techniques could be utilized.

The various cover composition layers of the present invention may be produced according to conventional melt blending procedures. Generally, the copolymer resins are blended in a Banbury® type mixer, two-roll mill, or extruder prior to neutralization. After blending, neutralization then occurs in the melt or molten states in the Banbury® mixer. Mixing problems are minimal because preferably more than 75 wt %, and more preferably at least 80 wt % of the ionic copolymers in the mixture contain acrylate esters and, in this respect, most of the polymer chains in the mixture are similar to each other. The blended composition is then formed into slabs, pellets, etc., and maintained in such a state until molding is desired. Alternatively, a simple dry blend of the pelletized or granulated resins, which have previously been neutralized to a desired extent, and colored masterbatch may be prepared and fed directly into the injection molding machine where homogenization occurs in the mixing section of the barrel prior to injection into the mold. If necessary, further additives such as an inorganic filler, etc., may be added and uniformly mixed before initiation of the molding process. A similar process is utilized to formulate the high acid ionomer resin compositions used to produce the inner cover layer. In one embodiment of the invention, a masterbatch of non-acrylate ester-containing ionomer with pigments and other additives incorporated therein is mixed with the acrylate ester-containing copolymers in a ratio of about 1-7 weight % masterbatch and 93-99 weight % acrylate ester-containing copolymer.

The golf balls of the present invention can be produced by molding processes which include but are not limited to those which are currently well known in the golf ball art. For example, the golf balls can be produced by injection molding or compression molding the novel cover compositions around a wound or solid molded core to produce an inner ball which typically has a diameter of about 1.50 to 1.67 inches. The core, preferably of a dual core configuration, may be formed as previously described.

The outer layer is subsequently molded over the inner layer to produce a golf ball having a diameter of 1.620 inches or more, preferably about 1.680 inches or more. Although either solid cores or wound cores can be used in the present invention, as a result of their lower cost and superior performance solid molded cores are preferred over wound cores. The standards for both the minimum diameter and maximum weight of the balls are established by the United States Golf Association (U.S.G.A.).

In compression molding, the inner cover composition is formed via injection at about 380° F. to about 450° F. into smooth surfaced hemispherical shells which are then positioned around the core in a mold having the desired inner cover thickness and subjected to compression molding at 2000 to 300° F. for about 2 to 10 minutes, followed by cooling at 500 to 70° F. for about 2 to 7 minutes to fuse the shells together to form a unitary intermediate ball. In addition, the intermediate balls may be produced by injection molding wherein the inner cover layer is injected directly around the core placed at the center of an intermediate ball mold for a period of time in a mold temperature of from 500 to about 100° F. Subsequently, the outer cover layer is molded around the core and the inner layer by similar compression or injection molding techniques to form a dimpled golf ball of a diameter of 1.680 inches or more.

As previously noted, the most preferred golf ball of the present invention utilizes at least one polyurethane material in its cover layer. In the event that a multi-layer cover assembly is employed, it is preferred that one, both, or all of the cover layers include a polyurethane material.

Concerning methods of forming such layers which contain polyurethane, it is particularly preferred to use a reaction injection molding technique.

Specifically, the preferred method of forming a polyurethane-containing layer for a golf ball according to the invention is by reaction injection molding (“RIM”). RIM is a process by which highly reactive liquids are injected into a closed mold, mixed usually by impingement and/or mechanical mixing in an in-line device such as a “peanut mixer,” where they polymerize primarily in the mold to form a coherent, one-piece molded article. The RIM process usually involves a rapid reaction between one or more reactive components such as polyether, or polyester, polyol, polyamine, or other material with an active hydrogen, and one or more isocyanate-containing constituents, often in the presence of a catalyst. The constituents are stored in separate tanks prior to molding and may be first mixed in a mix head upstream of a mold and then injected into the mold. The liquid streams are metered in the desired weight to weight ratio and fed into an impingement mix head, with mixing occurring under high pressure, e.g., 1,500 to 3,000 psi. The liquid streams impinge upon each other in the mixing chamber of the mix head and the mixture is injected into the mold. One of the liquid streams typically contains a catalyst for the reaction. The constituents react rapidly after mixing to gel and form polyurethane polymers. Polyureas, epoxies, and various unsaturated polyesters also can be molded by RIM.

RIM differs from non-reaction injection molding in a number of ways. The main distinction is that in RIM a chemical reaction takes place in the mold to transform a monomer or adducts to polymers and the components are in liquid form. Thus, a RIM mold need not be made to withstand the pressures which occur in a conventional injection molding. In contrast, injection molding is conducted at high molding pressures in the mold cavity by melting a solid resin and conveying it into a mold, with the molten resin often being at about 150 to about 350° C. At this elevated temperature, the viscosity of the molten resin usually is in the range of about 50,000 to about 1,000,000 centipoise, and is typically around 200,000 centipoise. In an injection molding process, the solidification of the resins occurs after about 10 to about 90 seconds, depending upon the size of the molded product, the temperature and heat transfer conditions, and the hardness of the injection molded material. Subsequently, the molded product is removed from the mold. There is no significant chemical reaction taking place in an injection molding process when the thermoplastic resin is introduced into the mold. In contrast, in a RIM process, the chemical reaction causes the material to set in less than about 5 minutes, often in less than 2 minutes, preferably in less than one minute, more preferably in less than 30 seconds, and in many cases in about 10 seconds or less.

If plastic products are produced by combining components that are preformed to some extent, subsequent failure can occur at a location on the cover which is along the seam or parting line of the mold. Failure can occur at this location because this interfacial region is intrinsically different from the remainder of the cover layer and can be weaker or more stressed. The present invention is believed to provide for improved durability of a golf ball cover layer by providing a uniform or “seamless” cover in which the properties of the cover material in the region along the parting line are generally the same as the properties of the cover material at other locations on the cover, including at the poles. The improvement in durability is believed to be a result of the fact that the reaction mixture is distributed uniformly into a closed mold. This uniform distribution of the injected materials eliminates knit-lines and other molding deficiencies which can be caused by temperature difference and/or reaction difference in the injected materials. The process of the invention results in generally uniform molecular structure, density and stress distribution as compared to conventional injection-molding processes.

Catalysts can be added to the RIM polyurethane system starting materials as long as the catalysts generally do not react with the constituent with which they are combined. Suitable catalysts include those which are known to be useful with polyurethanes and polyureas, such as tin and tertiary amine catalysts, certain strong bases, amine-epoxide combinations, certain tertiary amines, and various commercially available amine catalysts such as Dabco® from Air Products Co.; Polycal® available from Abbott Labs, or Niax® available from Union Carbide Co.

The reaction mixture viscosity should be sufficiently low to ensure that the empty space in the mold is completely filled. The reactant materials generally are preheated to 90° F. to 150° F. before they are mixed. In most cases it is necessary to preheat the mold to, e.g., 100 to 180° F., to ensure proper injection viscosity.

As indicated above, one or more cover layers of a golf ball can be formed from a polyurethane material according to the present invention.

After molding, the golf balls produced may undergo various further processing steps such as buffing, painting and marking as disclosed in U.S. Pat. No. 4,911,451, herein incorporated by reference.

The resulting golf ball produced from the hard inner layer and the relatively softer, low flexural modulus outer layer provide for an improved multi-layer golf ball having a unique dual core configuration which provides for desirable coefficient of restitution and durability properties while at the same time offering the feel and spin characteristics associated with soft balata and balata-like covers of the prior art.

Four golf balls in accordance with the present invention were formed, each using a preferred and commercially available high melting point thermoplastic material as an inner core component. Table 20, set forth below, summarizes these balls.

TABLE 20

| | | Capron ® | Lexan ® | Pebax ® | Hytrel ® | Control |
|---|---|---|---|---|---|---|
| | | 8351 | ML 5776-7539 | 3533 | G-4074 | (Single Core) |
| Inner Core | size (inches) | 0.835 | 0.854 | 0.840 | 0.831 | — |
| | weight (grams) | 5.33 | 6.14 | 5.08 | 5.81 | — |
| | rebound % (100″) | 78 | 83 | 65 | 61 | — |
| | Shore C (surface) | — | — | 57 | 73 | — |
| | Shore D (surface) | 75 | 83 | 36 | 47 | — |
| Outer Core | Cis 1,4 Polybutadiene | 100 | 100 | 100 | 100 | 100 |
| Formulation | Zinc oxide | 27 | 26 | 28 | 21 | 25 |
| | Zinc stearate | 16 | 16 | 16 | 16 | 25 |
| | Zinc diacrylate | 20 | 20 | 24 | 24 | 18 |
| | 231 XL | 0.9 | 0.9 | 0.9 | 0.9 | 0.9 |
| | | 163.9 | 162.9 | 168.9 | 161.9 | 158.9 |
| Double Core | size (inches) | 1.561 | 1.560 | 1.562 | 1.563 | 1.562 |
| Properties | weight (grams) | 37.7 | 37.8 | 37.8 | 37.5 | 37.8 |
| | compression (Riehle) | 79 | 80 | 99 | 93 | 114 |
| | COR | .689 | .603 | .756 | .729 | .761 |
| Molded Ball | size (inches) | 1.685 | 1.683 | 1.682 | 1.683 | 1.685 |
| Properties | weight (grams) | 45.3 | 45.5 | 45.5 | 45.2 | 45.4 |
| | compression (Riehle) | 78 | 80 | 89 | 87 | 102 |
| | COR | .750 | .667 | .785 | .761 | .788 |

| | | | | | |
|---|---|---|---|---|---|
| Cover Stock | Surlyn ® 8940 | 22 | *T.B. MB | Iotek ® 7030 | 75.35 |
| (used on all | Surlyn ® 9910 | 54.5 | | Unitane ® 0-110 | 23.9 |
| above balls) | Surlyn ® 8320 | 10 | | Ultra Marine ™ Blue | 0.46 |
| | Surlyn ® 8120 | 4 | | Eastobrite ® OB-1 | |
| | T.B. MB* | 9.5 | | Santonox ® R | 0.038 |
| | | 100.0 | | | 100.00 |

Generally, the inner cover layer which is molded over the core, or preferably a dual core component, is about 0.01 inches to about 0.10 inches in thickness, preferably about 0.03-0.07 inches thick. The inner ball which includes the core and inner cover layer preferably has a diameter in the range of 1.25 to 1.60 inches. The outer cover layer is about 0.01 inches to about 0.10 inches in thickness. Together, the core, the inner cover layer and the outer cover layer combine to form a ball having a diameter of 1.680 inches or more, the minimum diameter permitted by the rules of the United States Golf Association and weighing no more than 1.62 ounces.

Most preferably, the resulting golf balls in accordance with the present invention have the following dimensions:

TABLE 21

| Size Specifications: | | Preferred | Most Preferred |
|---|---|---|---|
| Inner Core | - Max. | 1.250″ | 1.00″ |
| | - Min. | 0.500″ | 0.70″ |
| Outer Core | - Max. | 1.600″ | 1.570″ |
| | - Min. | 1.500″ | 1.550″ |
| Cover Thickness | | | |
| | (Total) | | |
| | - Max. | 0.090″ | 0.065″ |
| | - Min. | 0.040″ | 0.055″ |

In a particularly preferred embodiment of the invention, the golf ball has a dimple pattern which provides coverage of 65% or more. The golf ball typically is coated with a durable, abrasion-resistant, relatively non-yellowing finish coat.

The present invention provides a particularly preferred method of forming a golf ball as follows. A density adjusting filler material is provided along with a polymeric core material suitable for use in forming a golf ball core. The materials are suitably mixed to form a center core component. A core layer material is selected having a composition different than the composition of the center core component. The center core component is appropriately placed in a mold or die suitable for forming golf ball cores and components as known in the art. A core layer is then formed from the core layer material. The core layer is formed about the center core component. A multi-layer cover assembly is then formed about the dual core assembly as follows. An inner cover material is provided and an inner cover layer is then formed from that material about the dual core assembly. This can be done by molding the inner cover layer about the dual core assembly residing or appropriately positioned within a mold. An outer cover layer comprising a polyurethane material is formed as follows. A polyurethane material is selected such that upon curing, the inner cover layer and the outer cover layer exhibit a hardness differential of at least 5. The polyurethane material may be appropriately mixed with other materials for forming the outer core layer. An outer core layer is then molded about the inner core layer.

In a particularly preferred version of this method, the polyurethane containing outer cover layer is formed from a reaction injection molding technique described herein. The component adapted for reacting with the isocyanate component is preferably a polyether component, a polyester component, a polyol component, a polyamine component, or combinations thereof. The outer cover layer is formed by reacting the isocyanate component and the component adapted for reacting with the isocyanate component to thereby form an outer cover layer.

The invention has been described with reference to the preferred embodiments. Obviously, modifications and alterations will occur to others upon a reading and understanding the preceding detailed description. It is intended that the invention be construed as including all such modifications and alterations in so far as they come within the scope of the appended claims or the equivalents thereof.

What is claimed is:

1. A golf ball comprising:
a dual core assembly including (i) a center core component and (ii) a core layer disposed about said center core component, said center core component having at least one density adjusting filler material dispersed throughout a polymeric material; and
a multi-layer cover assembly including (i) an inner cover layer disposed on said dual core assembly and (ii) an outer cover layer disposed on said inner cover layer, at least one of said inner cover layer and said outer cover layer comprising a polyurethane material, and said inner cover layer and said outer cover layer exhibiting a hardness differential of at least 5, as measured on the Shore D scale.

2. The golf ball of claim 1 wherein said density adjusting filler material is a density increasing material and has a specific gravity in the range of from about 1.0 to about 20.0.

3. The golf ball of claim 1 wherein said polymeric material of said center core is a thermoset material.

4. The golf ball of claim 1 wherein said polymeric material of said center core is a thermoplastic material.

5. The golf ball of claim 1 wherein said density adjusting material is selected from the group consisting of titanium, tungsten, nickel, molybdenum, iron, steel, lead, copper, brass, bronze, cobalt, zinc, tin, and combinations thereof.

6. The golf ball of claim 1 wherein said inner cover layer comprises an ionomeric material.

7. The golf ball of claim 1 wherein said inner cover layer has a thickness of from about 0.01 inches to about 0.10 inches.

8. The golf ball of claim 1 wherein said inner cover layer exhibits a Shore D hardness of at least 60.

9. The golf ball of claim 1 wherein said outer cover layer has a thickness of from about 0.01 inches to about 0.10 inches.

10. The golf ball of claim 1 wherein said outer cover layer exhibits a Shore D hardness of 55 or less.

11. The golf ball of claim 1 wherein said outer cover layer exhibits a Shore D hardness of 50 or less.

12. The golf ball of claim 1 wherein said hardness differential is at least 10, as measured on the Shore D scale.

13. The golf ball of claim 1 wherein said hardness differential is at least 15, as measured on the Shore D scale.

14. The golf ball of claim 1 wherein said hardness differential is at least 20, as measured on the Shore D scale.

15. The golf ball of claim 1 wherein said inner cover layer is harder than said outer cover layer.

16. The golf ball of claim 1 wherein said inner cover layer is softer than said outer cover layer.

17. The golf ball of claim 1 further comprising an outer co re layer disposed between said core layer and said inner cover layer.

18. The golf ball of claim 1 wherein said outer cover layer comprises a polyurethane material.

19. A golf ball comprising:
a center core component including a polymeric material and at least one density-increasing filler material having a specific gravity in the range of from about 1.0 to about 20.0;
a core layer disposed about said center core component, said core layer having a composition different than said center core component;
an inner cover layer disposed on said core layer, said inner cover layer having a thickness of from about 0.01 inches to about 0.10 inches;
an outer cover layer disposed on said inner cover layer, said outer cover layer having a thickness of from about 0.01 inches to about 0.10 inches, said outer cover layer comprising a polyurethane material;
wherein the hardness differential between said inner cover layer and said outer cover layer is at least 5 on the Shore D scale.

20. The golf ball of claim 19 wherein said hardness differential is at least 10.

21. The golf ball of claim 19 wherein said hardness differential is at least 15.

22. The golf ball of claim 19 wherein said hardness differential is at least 20.

23. The golf ball of claim 19 wherein said density-increasing filler material is selected from the group consisting of titanium, tungsten, nickel, molybdenum, iron, steel, lead, copper, brass, bronze, cobalt, zinc, tin, and combinations thereof.

24. The golf ball of claim 23 wherein said density-increasing filler material is titanium.

25. The golf ball of claim 23 wherein said density-increasing filler material is tungsten.

26. A method of forming a golf ball, said method comprising the steps of:
providing a density adjusting filler material;
providing a polymeric core material suitable for use in a golf ball core;
mixing said density adjusting filler material and said polymeric core material and forming a center core component;
providing a core layer material having a composition different than the composition of said center core component;
forming a core layer from said core layer material about said center core component;
providing an inner cover material;
forming an inner cover layer from said inner cover material on said core layer;
selecting a polyurethane material adapted for use in an outer cover layer such that upon curing said inner cover layer and said outer cover layer, the hardness differential between said inner cover layer and said outer cover layer is at least 5; and
forming an outer cover layer on said inner cover layer to thereby form said golf ball.

27. The method of claim 26 wherein said step of forming said outer cover layer utilizes reaction injection molding of said polyurethane material.

28. The method of claim 26 wherein said method further comprises:
providing an isocyanate component;
providing a component adapted for reacting with said isocyanate component selected from the group consisting of a polyether component, a polyester component, a polyol component, a polyamine component, and combinations thereof.
reacting said isocyanate component and said component adapted for reacting with said isocyanate component to thereby form said polyurethane material.
